(19) United States
(12) Patent Application Publication
(10) Pub. No.: US 2026/0061736 A1
(43) Pub. Date: Mar. 5, 2026

(54) WET GEL CUTTING TECHNOLOGY

(71) Applicant: Cardinal CG Company, Eden Prairie, MN (US)

(72) Inventors: Mohammad Arifuzzaman, Verona, WI (US); Kellen C. Kitzman, Verona, WI (US); Kari B. Myli, Sauk City, WI (US)

(21) Appl. No.: 19/313,121

(22) Filed: Aug. 28, 2025

Related U.S. Application Data
(60) Provisional application No. 63/689,221, filed on Aug. 30, 2024.

(51) Int. Cl. B32B 38/00; B32B 9/04

(52) U.S. Cl. CPC B32B 38/0004; B32B 9/04; B32B 2250/02; B32B 2307/72; B32B 2307/7376

(57) ABSTRACT

The invention provides a method of cutting a wet gel sheet. The method includes positioning a wet gel sheet on a cutting support surface, so that a bottom face of the wet gel sheet is supported by the cutting support surface. The wet gel sheet is a porous material comprising solvent in at least some pores. The wet gel sheet is cut by moving a blade along a cutting path. The invention also provides an aerogel sheet formed by a process that includes the cutting method, as well as certain articles that include the cut aerogel sheet.

### RELATED APPLICATIONS

This application claims priority to U.S. Provisional Patent Application No. 63/689,221, filed Aug. 30, 2024, the contents of which are incorporated herein by reference.

### FIELD OF THE INVENTION

The present invention relates to cutting wet gel in the production of aerogel. The present invention also relates to equipment for cutting wet gel.

### BACKGROUND OF THE INVENTION

Aerogel is a known insulation material. There has been an interest in using aerogel in window applications to improve the thermal insulation property of windows. It would be convenient to be able to cut aerogel sheets into different sizes to accommodate different window dimensions. However, this has been difficult to accomplish because aerogel sheets are particularly fragile. Some attempts have been made to cut aerogel sheets, but they introduce stress to the aerogel sheets and may cause them to crack or otherwise degrade, particularly along the cut edge faces.

It is desirable to provide a cutting method that can yield aerogel sheets having cut edge faces with high quality. It is particularly desirable to provide such a method that also is safe and does not adversely impact properties of the resulting aerogel sheets. It is also desirable to provide a cutting method that reduces or prevents cutting debris from accumulating on or otherwise impacting the resulting aerogel sheets. Further, it would be desirable to provide an aerogel sheet having a cut edge face formed by such a method. Still further, it would be desirable to provide an article comprising a glass sheet and an aerogel sheet carried alongside the glass sheet, where the aerogel sheet has a high quality cut edge face and exceptional properties.

### SUMMARY

Certain embodiments provide a wet gel cutting method. The method involves cutting a wet gel sheet that is a porous material having solvent within at least some pores. The method can include providing a wet gel sheet on a cutting support surface, so that a bottom face of the wet gel sheet is supported by the cutting support surface and a top face of the wet gel sheet faces in an opposite direction. The method can also include cutting the wet gel sheet by moving a blade along a cutting path such that a cutting edge of the blade moves from the top face of the wet gel sheet to the bottom face of the wet gel sheet. In certain cases, the wet gel sheet is stationary during the cutting. In some cases, the cutting support surface is a continuous, flat surface that is in contact with and supports an entirety of the bottom face of the wet gel sheet. For example, the continuous, flat surface can be a rigid surface.

In some cases, the method can include coating at least a portion of the wet gel sheet with a solution comprising the solvent and performing the cutting before the solution fully evaporates. In some cases, the portion(s) of the wet gel sheet that is coated can include select portion(s) that are more prone to drying out, such as areas of the top face or perhaps the edge areas. In other cases, it may desirable to coat multiple portions of the wet gel sheet, including those that are not prone to drying out. In some cases, it may be desirable to coat the entire wet gel sheet, for example by submerging the wet gel sheet in the solution.

The coating step can be accomplished in a variety of different ways such as spraying, misting, submerging or any other mechanism of depositing the solution on one or more portions of the wet gel sheet. The coating step can also be performed before, during or after the cutting is performed. Also, the coating step can be performed continuously or even at specific times during the cutting process. In certain embodiments, the method includes performing the cutting while continuously misting at least a portion of the wet gel sheet. In other embodiments, the wet gel sheet can be submerged (e.g., partially, or fully submerged) in a solution comprising the solvent during the cutting.

During the cutting, the wet gel sheet can lie along a first plane and the cutting path can extend along a second plane perpendicular to the first plane. In some cases, the first plane is a horizontal plane and the second plane is a vertical plane. The cutting can produce a cut vertical edge face on the wet gel sheet, the cut vertical edge face being perpendicular to the bottom face of the wet gel sheet. The cut vertical edge face can be devoid of cracks visible to the naked eye. In certain embodiments, the cutting does not remove any chemical component from the wet gel sheet or otherwise change a chemical composition of the wet gel sheet. Also, in some embodiments, the cutting minimizes cutting debris that may be left behind on the cut vertical edge face or other remaining portions of the cut wet gel sheet.

The wet gel sheet can have a thickness of from 1 mm to 7 mm. In certain embodiments, the wet gel sheet is an alcogel sheet and the solvent is an alcohol. The wet gel sheet can be a silica wet gel sheet. For example, the wet gel sheet is devoid of fibers. The wet gel sheet may not be wound before or after the cutting.

In certain cases, the solvent is a flammable solvent and the cutting does not produce a spark or flame. The flammable solvent can be selected from the group consisting of methanol, ethanol, isopropanol, N,N-dimethylformadide (DMF) and acetone.

In some cases, the blade has a thickness of 1000 microns or less. The blade can also have an edge angle of from 15 degrees to 45 degrees. Also, in some cases, the blade is elongated so as to extend entirely across a width or a length of the wet gel sheet during the cutting. The blade can move along the cutting path without vibrating. The blade can also be devoid of serrations. In certain embodiments, the cutting only involves the blade moving along the cutting path and is devoid of using any second blade or any laser.

In some embodiments, after cutting is performed, the method further includes steps for removing or separating away a portion of the wet gel sheet that is to be scrapped. Such steps help minimize cutting debris that may be left behind on the cut vertical edge face or other remaining portions of the cut wet gel sheet. In some embodiments, the blade itself is used to help separate the scrapped portion of the wet gel sheet. For example, in some cases, the method includes moving the cutting support surface away from the blade while the blade remains stationary and adjacent the bottom face of the wet gel sheet. As the cutting support surface moves away, the stationary blade helps sever the cut wet gel sheet from the scrapped portion. The blade may also have a blade height that extends from the cutting edge to a spine and is greater than a total thickness of the wet gel sheet. By providing a blade with such a height, more debris may be prevented from moving from the scrapped portion over to the cut wet gel sheet.

The cutting support surface may be moved away from the stationary blade in any desired fashion. In some cases, the cutting support surface may be provided on an underlying base such that the cutting support surface is movable (e.g., slidable) relative to the underlying base. This allows the cutting support surface (and cut wet gel sheet) to be easily movable away from the blade so that the blade can assist in separating the cut wet gel sheet from the portions of the wet gel sheet being scrapped.

In certain embodiments, the method includes, prior to the cutting, performing a solvent exchange on the wet gel sheet, such that prior to the solvent exchange the wet gel sheet contains water as the solvent whereas after the solvent exchange the wet gel sheet contains an alcohol as the solvent. Also, in some embodiments, the method includes, after the cutting, aging the wet gel sheet.

In certain embodiments, the method includes, after the cutting, drying the wet gel sheet to convert it to an aerogel sheet. For example, the drying the wet gel sheet involves a drying operation selected from the group consisting of supercritical drying, freeze drying and ambient drying. The aerogel sheet can be a transparent, brittle aerogel sheet.

Other embodiments provide an article including a glass sheet and an aerogel sheet, the aerogel sheet having a specified dimension and being located alongside a major surface of the glass sheet. In certain cases, the article is formed by a process including providing a wet gel sheet on a cutting support surface, so that a bottom face of the wet gel sheet is supported by the cutting support surface and a top face of the wet gel sheet faces in an opposite direction, the wet gel sheet being a porous material comprising solvent within at least some pores. The method also includes cutting the wet gel sheet to have the specified dimension by moving a blade along a cutting path such that a cutting edge of the blade moves from the top face of the wet gel sheet to the bottom face of the wet gel sheet, drying the wet gel sheet to form the aerogel sheet, and mounting the aerogel sheet alongside the major surface of the glass sheet.

In some cases, the aerogel sheet has a cut edge face, created by the cutting, that is devoid of cracks visible to the naked eye. The cut edge face can be a vertical cut edge face, the vertical cut edge face being perpendicular to the major surface of the glass sheet.

In one or more embodiments, the aerogel sheet has a thickness of from 1 mm to 7 mm, preferably from 3 mm to 5 mm. The aerogel sheet can be a transparent, brittle aerogel sheet having a major dimension of at least 0.6 meter. In some embodiments, the aerogel sheet is sufficiently rigid that it cannot be wound. The aerogel sheet can have a visible transmission of 95% or more. The aerogel sheet can have a haze value of less than 5%. The aerogel sheet can have a density of from 100 mg/cc to 200 mg/cc. The aerogel sheet can be a silica aerogel sheet. For example, the silica aerogel sheet can consist essentially of silica. In some embodiments, the aerogel sheet is devoid of fibers. In certain cases, the wet gel sheet is an alcogel sheet and the solvent comprises alcohol. For example, the alcogel sheet can be a silica alcogel sheet while the alcohol is methanol.

### BRIEF DESCRIPTION OF THE DRAWINGS

FIG. 1 is a schematic front view of a blade assembly relative to a wet gel sheet in accordance with certain embodiments;

FIG. 2 is a schematic side view of the blade assembly and wet gel sheet of FIG. 1;

FIG. 3 is a schematic front view of a blade assembly relative to a wet gel sheet in accordance with certain embodiments;

FIG. 4 is a schematic side view of the blade assembly and wet gel sheet of FIG. 3;

FIG. 5 is a schematic front view of a blade assembly relative to a wet gel sheet in accordance with certain embodiments;

FIG. 6 is a schematic side view of the blade assembly and wet gel sheet of FIG. 5;

FIG. 7 is a schematic front view of a blade assembly in a first position relative to a wet gel sheet in accordance with certain embodiments;

FIG. 8 is a schematic front view of the blade assembly of FIG. 7 in a second position;

FIG. 9 is a schematic front view of a blade assembly in a first position relative to a wet gel sheet in accordance with certain embodiments;

FIG. 10 is a schematic front view of the blade assembly of FIG. 9 in a second position;

FIG. 11 is a schematic front view of a blade assembly relative to a wet gel sheet in accordance with certain embodiments;

FIG. 12 is a schematic side view of a blade assembly relative to a cutting support surface in accordance with certain embodiments;

FIG. 13 is an enlarged side view of a blade assembly in accordance with certain embodiments;

FIG. 14 is an enlarged side view of a blade assembly in accordance with certain embodiments;

FIG. 15 is an enlarged side view of a blade assembly in accordance with certain embodiments;

FIG. 16 is an enlarged side view of a blade assembly in accordance with certain embodiments;

FIG. 17 is an enlarged side view of a blade assembly in accordance with certain embodiments;

FIG. 18 is an enlarged side view of a blade assembly in accordance with certain embodiments;

FIG. 19 is an enlarged side view of a blade assembly in accordance with certain embodiments;

FIG. 20 is a cutaway perspective view of a blade in accordance with certain embodiments;

FIG. 21 is a cutaway perspective view of a blade in accordance with certain embodiments;

FIG. 22 is a schematic side view of a portion of a blade penetrating a wet gel sheet in accordance with certain embodiments.

FIG. 23 is a schematic side view of a portion of a blade penetrating a wet gel sheet in accordance with certain embodiments.

FIG. 24 is a schematic side view of a portion of a blade penetrating a wet gel sheet in accordance with certain embodiments.

FIGS. 25A-25D are each schematic side views of cutting equipment to depict a cutting method in accordance with certain embodiments.

FIG. 26 is a top view of a wet gel sheet showing a cut line in accordance with certain embodiments;

FIG. 27 is a side view of the wet gel sheet of FIG. 26 showing the noted cut line;

FIG. 28 is a side view of a wet gel sheet showing a cut vertical edge face in accordance with certain embodiments;

FIG. 29 is a top view of a wet gel sheet showing a plurality of cut lines in accordance with certain embodiments;

FIG. 30 is a side view of the wet gel sheet of FIG. 29 showing two of the noted cut lines;

FIG. 31 is a side view of a wet gel sheet showing two cut vertical edge faces in accordance with certain embodiments;

FIG. 32 is a top view of a wet gel sheet showing a plurality of cut lines in accordance with certain embodiments;

FIG. 33 is a side view of the wet gel sheet of FIG. 32 showing two of the noted cut lines;

FIG. 34 is a side view of a wet gel sheet showing two cut vertical edge faces in accordance with certain embodiments;

FIG. 35 is a flow chart depicting a method in accordance with certain embodiments;

FIG. 36 is a flow chart depicting another method in accordance with certain embodiments;

FIG. 37 is a schematic, broken-away, cross-sectional side view of an article that includes a glass sheet and a cut aerogel sheet in accordance with certain embodiments;

FIG. 38 is a schematic, partially broken-away, cross-sectional side view of an insulating glazing unit that includes a cut aerogel sheet in accordance with certain embodiments;

FIG. 39 is a schematic, partially broken-away, cross-sectional side view of a laminated glass assembly that includes a cut aerogel sheet in accordance with certain embodiments;

FIG. 40 is a schematic front view of three sequential images of a blade assembly just prior to, during, and just after cutting a wet gel sheet in accordance with certain embodiments;

FIG. 41 is a schematic side view of four sequential images of the blade assembly just prior to, during, and just after cutting the wet gel sheet as illustrated in FIG. 40;

FIG. 42A is a top view of a wet gel sheet showing a plurality of uncut vertical edge faces in accordance with certain embodiments;

FIG. 42B is a side view of a wet gel sheet showing two uncut vertical edge faces in accordance with certain embodiments;

FIG. 43A is a top view of a wet gel sheet showing a plurality of cut vertical edge faces in accordance with certain embodiments; and

FIG. 43B is a side view of a wet gel sheet showing two cut vertical edge faces in accordance with certain embodiments.

### DETAILED DESCRIPTION OF PREFERRED EMBODIMENTS

The following detailed description is to be read with reference to the drawings, in which like elements in different drawings have like reference numerals. The drawings, which are not necessarily to scale, depict selected embodiments and are not intended to limit the scope of the invention. Skilled artisans will recognize that the examples provided herein have many useful alternatives that fall within the scope of the invention.

In the present specification, anywhere the terms “comprising” or “comprises” are used, those terms have their ordinary, open-ended meaning. In addition, where appropriate, the disclosure at each such location is to be understood to also disclose that it may, as an alternative, “consist essentially of” or “consist of.”

Applicant has discovered that aerogel sheets with high quality cut edge faces can be obtained by performing cutting when the material is in a wet gel form, as opposed to a dried aerogel form. Typically, a wet gel sheet is first formed and then later dried to become an aerogel sheet. Applicant has found that aerogel sheets are difficult to cut because they are brittle and prone to damage in the dried state. Often times, after cutting, aerogel sheets have undesirable cut edge faces with visible cracks and other damage. Also, aerogel sheets with cracks in the edge faces are prone to more damage as the cracks propagate.

In cases where the aerogel sheets are used in windows, the sheets must often be cut to have a specified dimension to be used with a glass sheet of a specific size. At the same time, the aerogel sheets should have excellent optical qualities with no visible damage. It is therefore desirable to provide aerogel sheets having cut edge faces that do not have cracks or other damage visible to the naked eye. Also, even if the cut edge faces are positioned outside the vision area of a window, cracks in the edge faces are prone to propagating through the aerogel sheet, rendering it unusable in a window.

Wet gel formation can cause the wet gel sheet to have undesirable edge features such as raised or jagged edge features. In some cases, the wet gel can develop a meniscus or uneven portion along the perimeter of the wet gel sheet. Applicant has found that the methods described herein can be used to perform cutting to remove any undesirable edge features, such as a meniscus, to provide a wet gel sheet (and subsequent aerogel sheet) having clean cut edge faces.

Applicant sought to provide cutting methods that allow for an aerogel sheet to have high quality cut edge faces that do not have cracks or other damage visible to the naked eye. Also, Applicant sought to provide cutting methods that minimize the amount of debris that is produced. Applicant has discovered that by cutting the sheets while they are in wet gel form, as opposed to dry aerogel form, a high quality cut edge face can be obtained. In particular, if the wet gel sheets are cut while solvent is still in the pores, it is surmised that the solvent helps to protect the wet gel structure during cutting and allows for better cut edge faces. Additionally, wet gel has a viscoelastic solid skeleton that is damaged to less extent during cutting as compared to aerogel, which commonly has a dried elastic, brittle skeleton. Finally, less debris is produced when cutting in wet gel form, which helps yield higher quality wet gel and resulting aerogel.

Applicant has therefore developed methods for cutting wet gel sheets. The cutting methods are performed before the wet gel sheets are dried to form aerogel sheets. Generally, the cutting methods involve providing a wet gel sheet on a cutting support surface such that that a bottom face of the wet gel sheet is supported by the cutting support surface and a top face faces away from the cutting support surface, and cutting the wet gel sheet.

In certain cases, a vertical cutting method is provided and involves positioning a wet gel sheet on a horizontal cutting support surface such that that a bottom face of the wet gel sheet is supported by the horizontal cutting support surface and a top face faces upward, and cutting the wet gel sheet from the top face towards the bottom face. In other cases, a horizontal, sideways cutting method is provided and involves positioning a wet gel sheet against a vertical cutting support surface such that a bottom face is supported by the vertical cutting support surface and the top face faces away, and cutting the wet gel sheet horizontally from the top face towards the bottom face. In other cases, an inclined cutting method is provided, such that the wet gel sheet is positioned at an incline during cutting.

The wet gel sheet is a porous material, and the cutting is performed while the wet gel sheet includes solvent in at least some pores. In some cases, the wet gel sheet is submerged in a solution comprising (or consisting essentially of) solvent during the cutting. In certain cases, the wet gel sheet is fully submerged in the solution comprising (or consisting essentially of) solvent during the cutting, such that the top face of the wet gel sheet is beneath the surface of the solution.

In other cases, at least a portion of the wet gel sheet is coated and/or wetted with a solution comprising (or consisting essentially of) solvent. For example, the solution can optionally be provided to the wet gel sheet by spraying and/or misting at least a portion of the wet gel sheet. The portion of the wet gel can include areas of the top face or the entire top face. In one or more embodiments, the cutting preferably is performed before the solution fully evaporates. Thus, in some cases, the cutting is performed while continuously misting and/or spraying at least a portion of the wet gel sheet with the solution.

The cutting is performed by moving a blade along a cutting path such that a cutting edge of the blade cuts the wet gel sheet. In some cases, the cutting edge moves from the top face to the bottom face to completely cut the wet gel sheet. In other cases, the cutting edge initially moves only partially from the top face to the bottom face, e.g., to score the top face of the wet gel sheet, or to otherwise initially make a partial cut. In specific cases, the cutting includes two steps: a first step of partially cutting to make a score or other partial cut in the wet gel sheet, and a second step of cutting through an entirety of the remaining thickness of the wet gel sheet, where the partial cut was initially made, to make a complete cut. In yet other cases, the cutting edge moves through the wet gel sheet from one edge face to another edge face (rather than from a top face to a bottom face).

Solvent is present within at least some (optionally all) pores of the wet gel sheet during cutting. In some cases, the solvent is an alcohol. Thus, in some cases, the cutting is performed on a wet gel sheet that is an alcogel. In certain cases, the alcohol can be an aliphatic alcohol such as methanol, ethanol and isopropanol. In other cases, the alcohol can be an aromatic alcohol, e.g., benzyl alcohol. In yet other cases, the solvent is a non-alcohol such acetone, N,N-dimethylformadide (DMF), dimethylsulfoxide (DMSO) and water. In certain cases, the solvent is water, and the cutting is performed on a wet gel sheet that has been synthesized but not yet subjected to a solvent exchange. In other cases, two solvents may be present within at least some (optionally all) of the pores, e.g., water and alcohol.

In some cases, the solvent is a flammable solvent. As used herein, the term “flammable solvent” refers to a solvent that has a flash point of 60° C. or less. The flash point is the lowest temperature at which a solvent can produce enough vapor to form an ignitable mixture with air near its surface. If a solvent is heated to or above its flash point, an external ignition source (like a spark or flame) can ignite the vapor. In some cases, the solvent can be a flammable solvent selected from the group consisting of methanol, ethanol, isopropanol, acetone and DMF. In certain cases, the solvent can be a flammable alcohol selected from the group consisting of methanol, ethanol and isopropanol.

In certain embodiments, Applicant provides a mechanical cutting method that does not generate sufficient heat and/or aerosol to pose a fire risk in the presence of a flammable solvent. In some cases, the cutting method is devoid of using any high power tools, such as a laser or ultrasonic equipment, which can generate significant heat. Similarly, in some cases, the cutting method is devoid of using a component that moves in a repetitive motion, such as a vibrating motion or a sawing motion, which also can produce unwanted heat and/or aerosol and may be more damaging. In other embodiments though, such as those that do not use a flammable solvent, the cutting method may use ultrasonic equipment or repetitive motion to perform the cutting.

During cutting, the wet gel sheet preferably remains stationary, as opposed to being conveyed or otherwise moving relative to the cutting equipment. This can optionally be the case for any embodiment of the present disclosure. For example, the wet gel sheet can remain stationary as it is supported by the cutting support surface (e.g., with a bottom face being supported by the cutting support surface and the top face facing away from the support surface).

Applicant discovered that when the cutting support surface is a continuous, flat surface, higher quality cut edge faces are obtained compared to when the cutting support surface includes gaps (such as a mesh surface). Thus, the cutting support surface is desirably a continuous, flat surface. Further, the cutting support surface is preferably a rigid surface. In some cases, the cutting support surface is a glass sheet. In other cases, the cutting support surface is a bottom surface of a tray or mold.

Applicant's method uses a blade having any desired shape. In some cases, the blade is an elongated blade that extends across a portion (or an entirety) of the wet gel sheet. If desired, the blade can be elongated so as to extend beyond the width or the length of the wet gel sheet during cutting. Also, in some cases, the blade has a height that is greater than a thickness of the wet gel sheet. In other cases, the blade has a circular shape that rotates through the wet gel sheet. In yet other cases, the blade has a razor shape or chisel shape that drags (e.g., moves linearly without rotating) through the wet gel sheet.

Regardless of the shape, the blade preferably has a thin blade thickness. As used herein, the blade thickness is a maximum thickness of the blade extent that penetrates the wet gel sheet during cutting. In many cases, the blade has a thickness of 1000 microns or less, such as 900 microns or less, 800 microns or less, 700 microns or less, 600 microns or less, 500 microns or less, 400 microns or less, 300 microns or less, 200 microns or less, or 100 microns or less. Applicant has found that blades with such a small thickness produce cleaner cut edge faces than those cut with a larger thickness. Thus, a blade thickness within any one or more of the ranges mentioned in this paragraph can optionally be used in any embodiment of this disclosure.

Additionally, the blade preferably has a desired edge angle. As used herein, the edge angle is an angle between the longitudinal axis and the cutting edge of the blade. In many cases, the edge angle is from 15 degrees to 45 degrees, for example from 20 degrees to 30 degrees. Applicant has found that such an edge angle helps provide cleaner cut edge faces. If desired, an edge angle within either or both of these ranges can be used, optionally in combination with a blade thickness within any one or more of the ranges mentioned in the preceding paragraph. Such a combination of edge angle and blade thickness can optionally be used in any embodiment of this disclosure.

Further, in some embodiments, the blade moves along a cutting path in a direction towards or along the cutting support surface. The cutting path can be a vertical cutting path, a horizontal cutting path, an inclined cutting path or a rotational cutting path that moves in a direction towards or along the cutting support surface.

In certain embodiments, the cutting path extends in a plane that is perpendicular to the cutting support surface. Such a cutting path can allow the cutting edge to produce a cut vertical edge face on the wet gel sheet. In such cases, the cut vertical edge face is generally perpendicular to a top and/or bottom face of the wet gel sheet.

In alternate embodiments, the cutting path extends in a plane that is not perpendicular to the cutting support surface. In some cases, the cutting path takes place at an incline. Such a cutting path would produce a non-vertical cut edge face on the wet gel sheet. Thus, the cut edge face can be an angled edge face.

In other embodiments, the blade can move along two or more cutting paths. For example, the blade can first move along a first cutting path in one direction (e.g., a vertical direction), and then move along a second cutting path in a second direction (e.g., a horizontal direction). In some cases, both of the cutting paths may extend in a plane perpendicular to the cutting support surface.

Regardless of the edge face type, the cut edge face is preferably devoid of cracks or other damage visible to the naked eye, even after the wet gel sheet is dried to form an aerogel sheet. The cutting method also preferably does not remove any chemical component from the wet gel sheet or otherwise change a chemical composition of the wet gel sheet. The cutting method also preferably minimizes debris that may collect on the wet gel sheet.

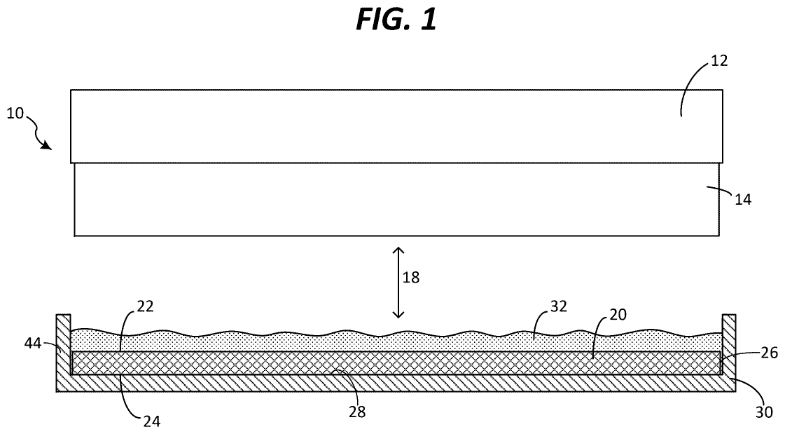

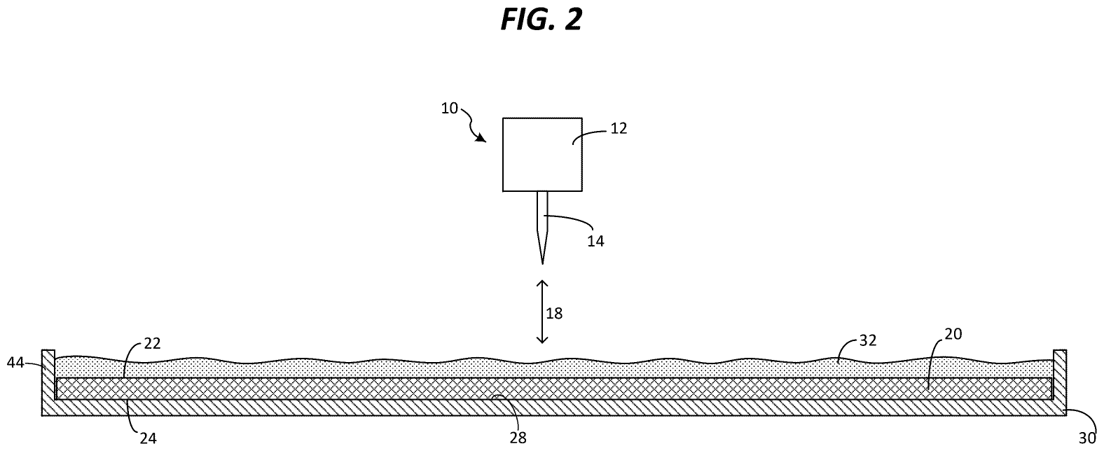

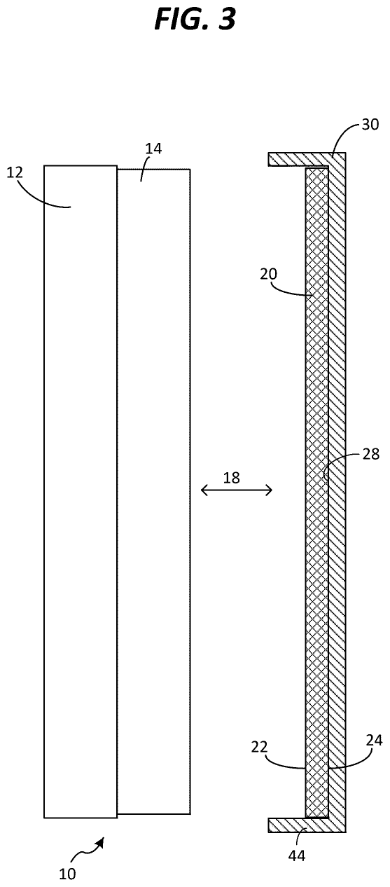

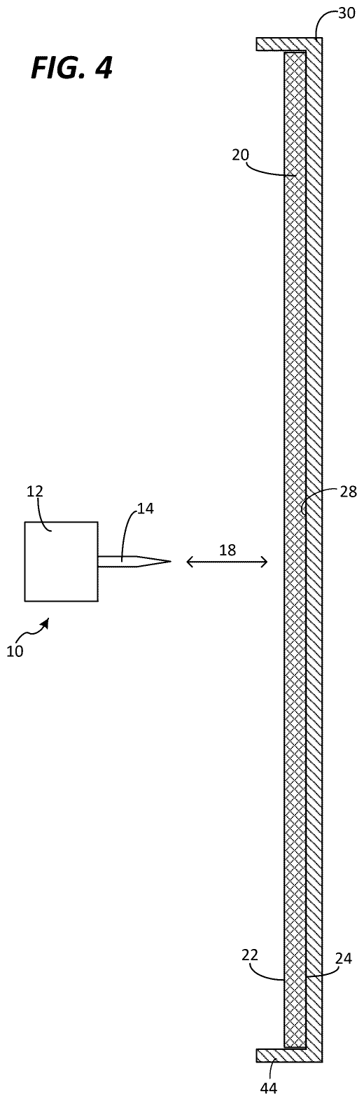

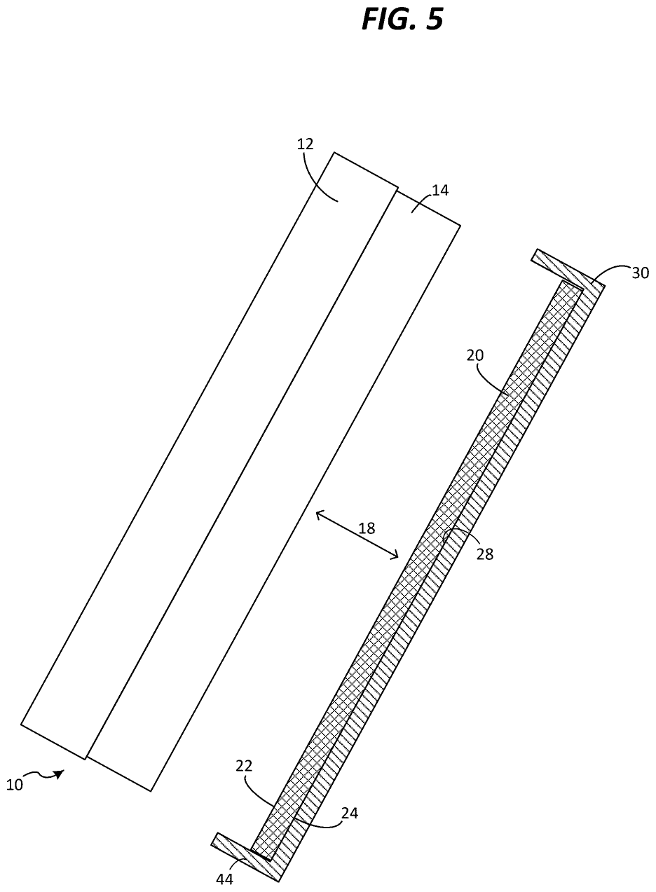

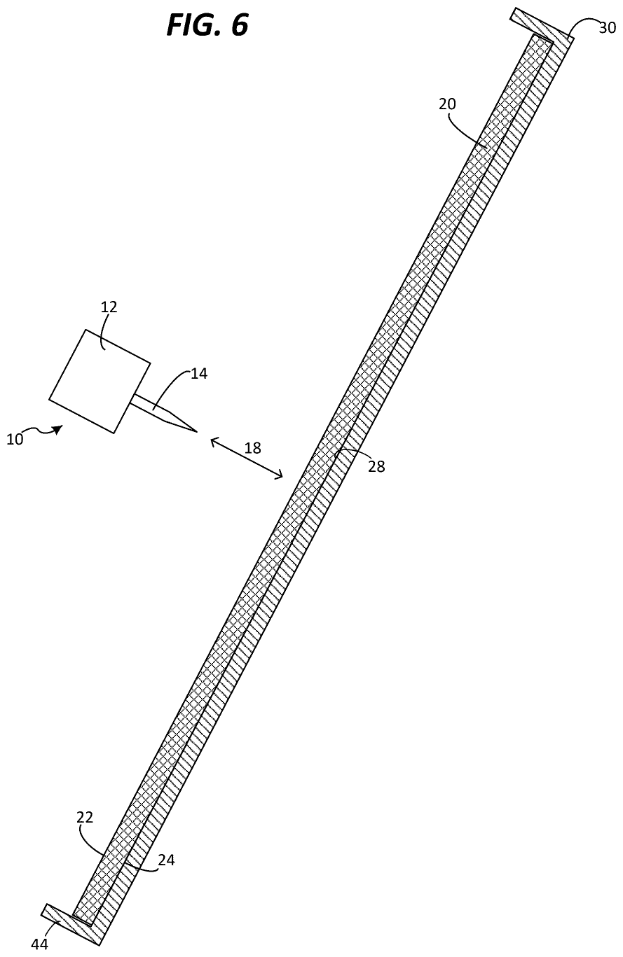

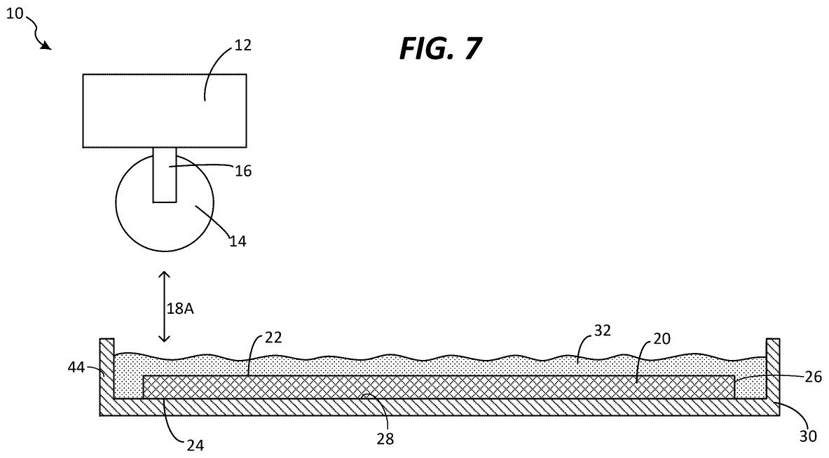

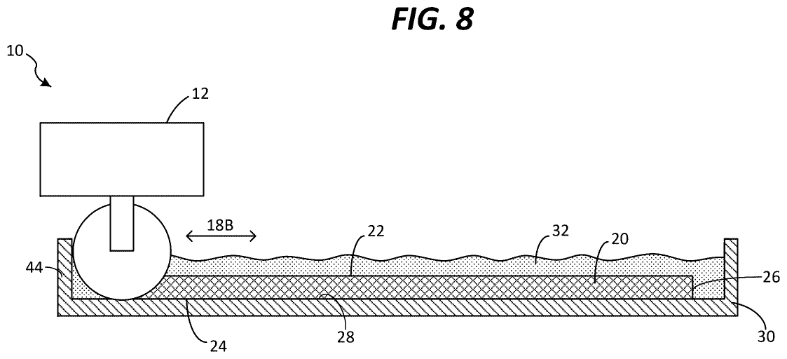

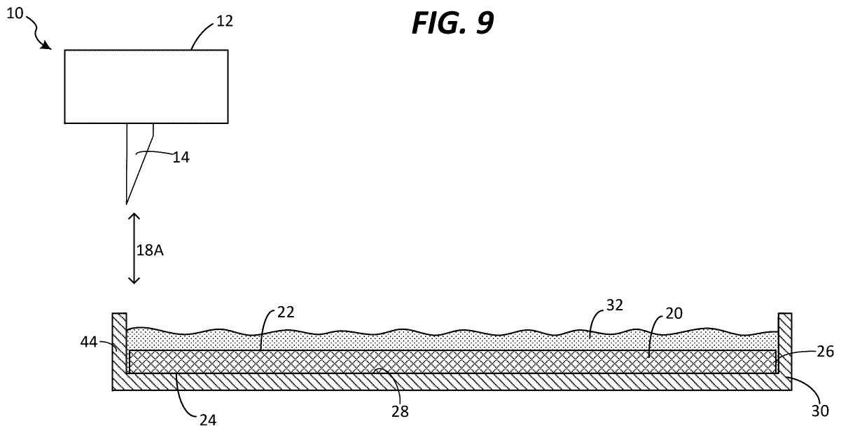

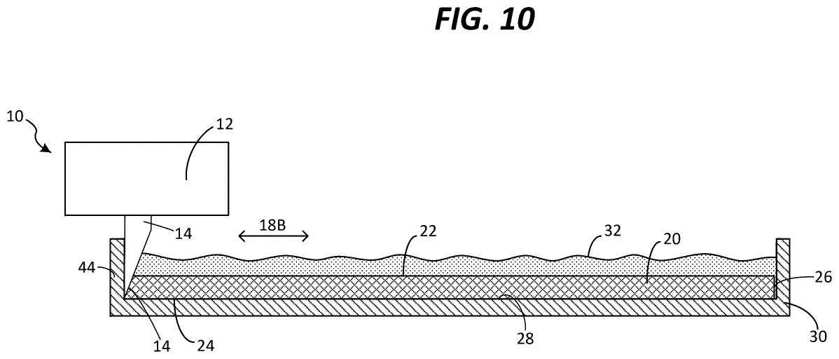

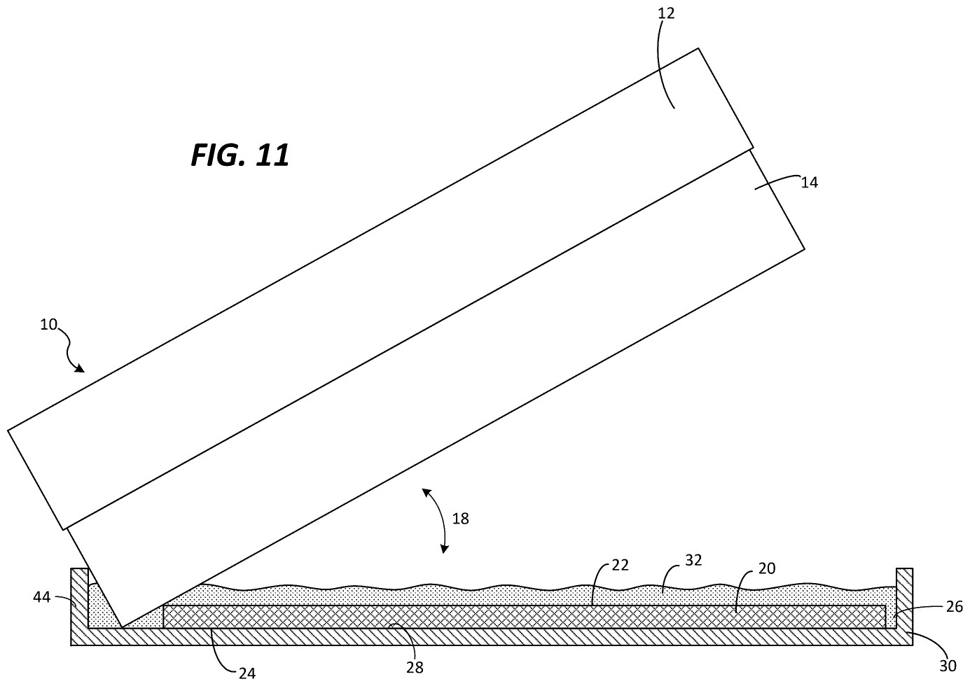

FIGS. 1-12 illustrate embodiments of equipment used in a cutting method. A blade assembly 10 is provided that includes a blade support 12 and a blade 14. The blade 14 is mounted on or otherwise supported by (e.g., depends from or extends from) the blade support 12. The blade 14 also extends partially or entirely across a width or length of a wet gel sheet 20. The blade 14 moves (e.g., vertically as shown in FIGS. 1-2, horizontally as shown in FIGS. 3-4, at an incline as shown in FIGS. 5-6, vertically and then horizontally and rotationally as shown in FIGS. 7-8, vertically and then horizontally as shown in FIGS. 9-10, or rotationally as shown in FIG. 11) along one or more cutting paths to cut a wet gel sheet 20. The blade 14 thereby comes into contact with the wet gel sheet 20 and penetrates it. In some cases, the blade 14 initially penetrates the wet gel sheet 20 only enough to score it or otherwise partially cut it. In other cases, the blade 14 completely cuts through the wet gel sheet 20 in a single pass.

In FIGS. 1-2, the blade 14 is configured as an elongated blade and the cutting path 18 is a vertical cutting path that extends along a vertical plane. In a starting position, the blade 14 is above the wet gel sheet 20, which lies along a horizontal plane. The blade 14 is then moved downward along the vertical cutting path 18. The vertical cutting path 18 in this embodiment extends in a vertical plane that is perpendicular to the wet gel sheet 20 and cutting support surface 28.

In FIGS. 3-4, the blade 14 is configured as an elongated blade and the cutting path 18 is a horizontal cutting path that extends along a horizontal plane. In a starting position, the blade 14 is positioned alongside the wet gel sheet 20, which is located along a vertical plane. The blade 14 is then moved horizontally along the cutting path 18. The horizontal cutting path 18 in this embodiment extends in a horizontal plane that is perpendicular to the wet gel sheet 20 and cutting support surface 28.

In FIGS. 5-6, the blade 14 is configured as an elongated blade and both the blade 14 and the wet gel sheet 20 are provided at an incline. The blade 14 moves along an inclined cutting path 18. In a starting position, the blade 14 is spaced apart from and confronting the wet gel sheet 20, which is located along an inclined plane. The blade 14 is then moved at an inclined angle along the cutting path 18. In this embodiment, the inclined cutting path 18 extends in a plane that is also perpendicular to the wet gel sheet 20 and the cutting support surface 28, which are also provided at an incline.

In FIGS. 7-8, the blade 14 is configured as a rotatable circular blade. The circular blade 14 is coupled to the blade support 12 such that it rotates freely. In some cases, the blade support 12 includes an axle or bearing or other structure 16 coupled to (e.g., carrying) the rotatable circular blade 14.

In such embodiments, the rotatable circular blade 14 can optionally move along a first cutting path 18A shown in FIG. 7 and then along a second cutting path 18B shown in FIG. 8. The first cutting path 18A is a vertical cutting path that extends in a vertical plane. The second cutting path 18B is a horizontal cutting path extending in a horizontal plane. In this embodiment, both the first vertical cutting path 18A and the second horizontal cutting path 18B extend in a plane that is perpendicular to the wet gel sheet 20 and cutting support surface 28.

The circular blade 14 can first move downward along the first vertical cutting path 18A shown in FIG. 7 to initially cut a portion of the wet gel sheet 20 from a top face 22 to a bottom face 24. After the initial cut, the circular blade 14 is adjacent to or in contact with the cutting support surface 28. The circular blade 14 can then move horizontally along the second horizontal cutting path 18B shown in FIG. 8 to cut through the remainder of the wet gel sheet 20, from one edge face to an opposite edge face. As the circular blade 14 moves horizontally, it also rotates to cut through the wet gel sheet 20.

In other embodiments, the circular blade 14 only moves through the wet gel sheet 20 along the horizontal cutting path 18B shown in FIG. 8. In such embodiments, the circular blade 14 is moved to be (or simply has a starting position) adjacent to or in contact with the cutting support surface 28 at a position to a side of an edge face of the wet gel sheet 20. The circular blade 14 then moves horizontally along the horizontal cutting path 18B to rotate and cut through the wet gel sheet 20, from one edge face to another edge face.

While FIGS. 7-8 shows the cutting support surface 28 in a horizontal position similar to how it is shown in FIGS. 1-2, it can alternative be positioned vertically (e.g., as shown in FIGS. 3-4) or at an incline (e.g., as shown in FIGS. 5-6).

In FIGS. 9-10, the blade 14 is configured as a razor or chisel. In this embodiment, the blade 14 moves along a first cutting path 18A shown in FIG. 9 and then along a second cutting path 18B shown in FIG. 10. The first cutting path 18A is a vertical cutting path that extends in a vertical plane. The second cutting path 18B is a horizontal cutting path extending in a horizontal plane. In this embodiment, both the first vertical cutting path 18A and the second horizontal cutting path 18B extend in a plane that is perpendicular to the wet gel sheet 20 and cutting support surface 28.

The blade 14 can first move downward along a vertical cutting path 18A shown in FIG. 9 to initially cut a portion of the wet gel sheet 20 from a top face 22 to a bottom face 24. After the initial cut, the blade 14 is adjacent to or in contact with the cutting support surface 28. The blade 14 can then move horizontally along the second cutting path 18B shown in FIG. 10 to cut through the remainder of the wet gel sheet 20, from one edge face to an opposite edge face.

In other embodiments, the blade 14 only moves through the wet gel sheet 20 along the horizontal cutting path 18B shown in FIG. 10. In such embodiments, the blade 14 is moved to be (or simply has a starting position) adjacent to or in contact with the cutting support surface 28 at a position to a side of an edge face of the wet gel sheet 20. The blade 14 then moves (e.g., is dragged) horizontally along the horizontal cutting path 18B to cut through the wet gel sheet 20 from one edge face to another edge face. Further, while FIGS. 9-10 show the cutting support surface 28 in a horizontal position similar to how it is shown in FIGS. 1-2, it can alternative be positioned vertically (e.g., as shown in FIGS. 3-4) or at an incline (e.g., as shown in FIGS. 5-6).

In FIG. 11, the blade 14 is configured as an elongated blade and the cutting path 18 is a rotational (e.g., pivotal) cutting path. The blade 14 is coupled to the blade support 12, which in turn can be coupled to a pivot point. The blade support 12 can include a lever, arm, handle or other structure (not shown) that can pivot the blade 14 along the pivot point. As the blade 14 pivots toward the cutting support surface 28, it cuts through the wet gel sheet 20 from a top face 22 to a bottom face 24.

The rotational (e.g., pivotal) cutting path 18 extends along a plane that is perpendicular to the wet gel sheet 20 and cutting support surface 28. Also, while FIG. 11 shows the cutting support surface 28 in a horizontal position similar to how it is shown in FIGS. 1-2, it can alternatively be positioned vertically (e.g., as shown in FIGS. 3-4) or at an incline (e.g., as shown in FIGS. 5-6).

In the embodiments of FIGS. 1-12, the illustrated cutting paths extend along a plane that is perpendicular to the wet gel sheet 20, and the resulting cut edge face is a vertical cut edge face. However, in other embodiments, a cutting path 18 may extend along a plane that is not perpendicular to the wet gel sheet 20, and the resulting cut edge face is inclined at a desired non-orthogonal angle.

As the cutting edge 144 contacts the wet gel sheet 20, it penetrates it. In some cases, the blade 14 penetrates only a portion of the wet gel sheet along the top face, e.g., to score it or otherwise cut only partially through a thickness of the wet gel sheet. In other cases, the blade 14 moves entirely through the wet gel sheet 20, e.g., in a single pass along a cutting path, until a cut is complete. In yet other cases, a single blade 14, e.g., a circular rotating blade or a razor blade, may first move along a first cutting path and then move along a second cutting path to make a cut. After the score or cut is made, the blade 14 is eventually returned to its original position and is ready for the next score or cut.

In some cases, both the blade support 12 and the blade 14 move together along the cutting path 18. In such cases, the blade 14 does not move separately relative to the blade support 12. Also, in some cases, the blade assembly 10 is connected to a load cell sensor (not shown) or other suitable sensor to monitor desired parameters (e.g., the speed, applied force and/or load or detected force and/or load) of the cutting method.

In some embodiments, a cutting path 18 is provided that is fixed along a single plane. For example, while the blade 14 moves along the cutting path 18, it preferably does not shift or move sideways or laterally relative to the single plane. Rather, the blade 14 itself preferably has a fixed side-to-side position, such that the cutting is achieved purely through motion (optionally linear motion) along the cutting path 18. Such embodiments are particularly desirable when the wet gel sheet 20 includes a flammable solvent in its pores. By preventing lateral movement and sawing motion, unwanted heat generation and/or aerosol is avoided, and a precise cut through the wet gel sheet 20 can be obtained. In alternative embodiments, such as those where a flammable solvent is not used, the blade 14 can have lateral movement such as ultrasonic vibration movement or sawing movement.

The wet gel sheet 20 has a top face 22, a bottom face 24 and edge faces 26. The bottom face 24 is supported by the cutting support surface 28 (e.g., a platen, a glass sheet, flat plate, or tray). The cutting support surface 28 preferably is a continuous, flat surface that is in contact with the bottom face 24 (optionally an entirety of the bottom face) of the wet gel sheet 20. This can optionally be the case for any embodiment of the present disclosure. In such cases, the cutting support surface 28 preferably is devoid of mesh, pores or other gaps. The cutting support surface 28, for example, can be defined by a platen or other flat plate. In such cases, the platen may be formed of metal, glass, or polymer. The cutting support surface 28 can advantageously be rigid.

The cutting support surface 28 can be provided as part of another structure. In some cases, the cutting support surface 28 can be a bottom inside surface of a tray or mold 30. The wet gel sheet 20 can be provided within the tray 30 such that it is supported by the cutting support surface 28.

The wet gel sheet 20 includes solvent within at least some pores. In some cases, the method can include coating or otherwise wetting at least a portion of the wet gel sheet with a solution comprising the solvent (e.g., a solution consisting essentially of the solvent) and performing the cutting before the solution fully evaporates. Such coating and/or wetting steps may be desirable to help reduce warping or other undesirable surface features due to uneven wetting or premature drying. In some cases, the portion(s) of the wet gel sheet that is coated or otherwise wetted can include select portion(s) that are more prone to drying out, such as areas of the top face or perhaps the edge areas. In other cases, it may desirable to coat or otherwise wet multiple portions of the wet gel sheet, including those that are not prone to drying out. In some cases, it may be desirable to coat or otherwise wet the entire wet gel sheet, for example by submerging the wet gel sheet in the solution.

The coating and/or wetting step can be accomplished in a variety of different ways such as spraying, misting, submerging or any other mechanism of depositing the solution on one or more portions of the wet gel sheet. The coating step can be performed before, during or after the cutting is performed. Also, the coating step can be performed continuously, or just at specific times, during the cutting process. In certain embodiments, the method includes performing the cutting while continuously misting at least a portion of the wet gel sheet. In other embodiments, the wet gel sheet can be submerged (e.g., partially or fully submerged) in a solution comprising the solvent during the cutting.

In some embodiments, the wet gel sheet 20 can be submerged in a solution comprising (optionally consisting essentially of) solvent 32, e.g., inside a tray 30, if desired. In certain cases, the wet gel sheet 20 can be fully submerged in a solution comprising (or consisting essentially of) solvent 32 such that the solution covers a top face 22.

In other embodiments, portions of the wet gel sheet 20 are misted (or sprayed) with a solution that includes the solvent 32. For example, it may be desirable to continuously mist the edge faces 26 of the wet gel sheet 20 during cutting. This is because the edge faces 26 typically dry faster than other portions since they are exposed to more air. In certain cases, it may be desirable to continuously mist the top face 22 of the wet gel sheet 20 during cutting to prevent the top face 22 from drying out. In other cases, it may be desirable to continuously mist or spray the entire top face 22 and each of the edge faces 26 with the solution comprising the solvent 32. In other cases, the cutting may be performed in a high humidity environment to slow or prevent evaporation of the solvent 32 from the wet gel sheet 20.

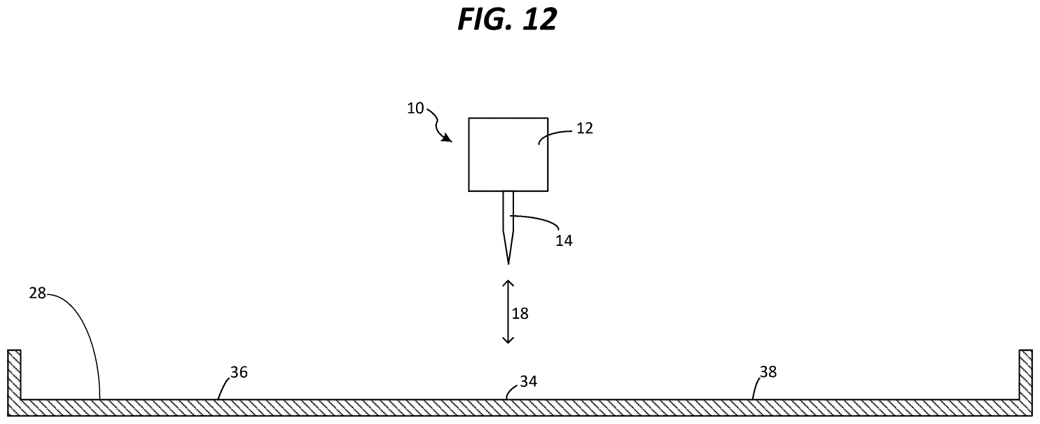

Referring to FIG. 12, the cutting support surface 28 can include a backing surface area 34 that is located directly opposite (e.g., directly aligned with, such as directly under or directly in front of) the blade 14. The blade 14 preferably cuts the wet gel sheet 20 against the backing surface area 34. This can optionally be the case for any embodiment of the present disclosure. In addition, the cutting support surface 28 preferably includes front adjacent surface area 36 and rear surface area 38. The front adjacent surface area 36 is located to a front side of the blade 14, and the rear adjacent surface area 38 is located to a rear side of the blade 14. In cases where the support surface 28 extends along a vertical or inclined plane, the front adjacent surface area 36 may be located beneath the blade 14, and the rear adjacent surface area 38 may be located above the blade 14.

The preferred backing surface area 34, front adjacent surface area 36 and rear adjacent surface area 38 are all continuous to one another. In some cases, backing surface area 34, the front adjacent surface area 36 and the rear adjacent surface area 38 are all flat, horizontal and parallel to one another. All these surface areas, for example, can be defined by a single platen, such as a single flat plate or an inside bottom surface of a tray 30.

In some cases, the backing surface area 34 can include (e.g., be provided with) retention features that help keep the wet gel sheet 20 stable and stationary during cutting. Such retention features may help prevent the wet gel sheet from shifting or rotating during cutting. Exemplary features include but are not limited to notches, indentations, surface treatments and surface textures. In such cases, the backing surface area 34 may provide a pinch or indent cut support. While FIG. 12 shows the cutting support surface 28 in a horizontal position, similar to how it is shown in FIGS. 1-2 and 7-11, it can alternatively be positioned vertically (e.g., as shown in FIGS. 3-4) or at an incline (e.g., as shown in FIGS. 5-6).

The blade 14 preferably moves along the cutting path 18 at a controlled speed. In such cases, the blade assembly 10 can be connected to a mechanism (such as one or more hydraulic or pneumatic cylinders, not shown) that moves the blade 14 along the cutting path at a controlled speed. In certain cases, the blade 14 moves at a speed of from 5 mm/second to 500 mm/second, such as from 5 mm/second to 15 mm/second. In some cases, the controlled speed remains constant during cutting. In certain cases, the controlled speed remains at a constant speed of from 5 mm/second to 500 mm/second, such as from 5 mm/second to 15 mm/second. In other cases, an initial cut (e.g., score) takes place at an initial speed and then a subsequent cut takes place at a faster speed than the initial speed. Suitable mechanisms that can be used to impart a controlled blade speed include hydraulic mechanisms, pneumatic mechanisms and various electrical motor mechanisms. Any cutting embodiment of this disclosure can optionally use a blade speed within on or both of these ranges.

Also, the blade 14 can move along the cutting path under a load. In a preferred embodiment, the load is proportional to a cut line of the wet gel sample. For example, a length of the blade 14 is generally about 2 inches longer than the cut line 40 of the sample. There may be about 1 inch on each side of the cut line. In some cases, the blade 14 is under a load of 7 Newtons or less (e.g., 5 Newtons or less, or 4 Newtons or less) upon penetrating (i.e., when initially penetrating the top face of) the wet gel sheet. Additionally or alternatively, the blade 14 can optionally be under a load of 12 Newtons or less upon breaking through the wet gel sheet. These loads are based on using a 5 inch by 5 inch wet gel sample. The loads may be higher with larger samples.

In one or more embodiments, a blade (e.g., 100 inch or 120 inch blade) is used to cut a variety of different wet gel sizes. The load used will then depend on the cut line size. For example, if the cut line is 35 inches, the load might be 49 Newtons. If the cut line is 96 inches, the load might be 140 Newtons. It is to be appreciated that these details are merely examples; they are by no means limiting.

The relationship between the cutting force detected (F) and the wet gel cutting length (L) in contact with the blade is as follows:

$$F = KLT$$

K is equal to the force per unit gel length (a constant for a specific blade and material). L is equal to the length of the cutting gel in contact with the blade-tip line. T is equal to wet gel thickness.

Table 1 summarizes experimental data showing a constant cutting force factor for cutting force detected vs. wet gel cutting length in contact with the blade. For each blade body thickness, (i) the density of the tested wet gel (corresponding to 120 mg/cc when ultimately measured as aerogel), (ii) aging period (10-days), (iii) thickness of the wet gel monolith (3.5 mm), and (iv) dropdown speed of the cutting blade (10 mm/s) were kept constant.

TABLE 1

| Blade | Wet Gel | | | | | Cutting Force |
|---|---|---|---|---|---|---|
| Thickness | Cutting | Cutting Force Detected [N] | | | | Factor |
| [micron] | Length [mm] | F1 | F2 | F3 | Mean | [N/mm] |
| 1000 | 118 | 5.85 | 5.92 | 6.00 | 5.92 | 0.05020 |
| | 80 | 3.97 | 4.05 | 4.05 | 4.02 | 0.05029 |
| 100 | 117 | 4.20 | 4.05 | 4.12 | 4.12 | 0.03524 |
| | 80 | 2.70 | 2.77 | 2.92 | 2.80 | 0.03496 |

The cutting force factor for a 100 micron thick blade is about 0.035 N/mm (see Table 1). Thus, to cut a 36 inch wet gel sheet (36 inch cut line) with a blade that is 100 microns thick and 50 inches long, the cutting force is about 32 N ((36 in.)*(25.4 mm)*(0.035 N/mm)=32 N). To cut a 48 inch wet gel sheet (48 inch cut line) with a blade that is 100 microns thick and 50 inches long, the cutting force is about 42.67 N ((48 in.)*(25.4 mm)*(0.035 N/mm)=42.67 N). The cutting force factor for a 1000 micron thick blade is about 0.05 N/mm (see Table 1). Thus, the overall cutting force to cut a 36 inch wet gel sheet (36 inch cut line) is about 45.72 N ((36 in.)*(25.4 mm)*(0.05 N/mm)=45.72 N).

The blade breaks through the wet gel sheet once the sheet is completely cut (i.e., when the blade breaks through the bottom face of the wet gel sheet). The controlled speed and load can be selected after considering a number of different parameters, including the material, density and thickness of the wet gel sheet, the length of the cut line across the wet gel sheet, and the shape of the blade 14.

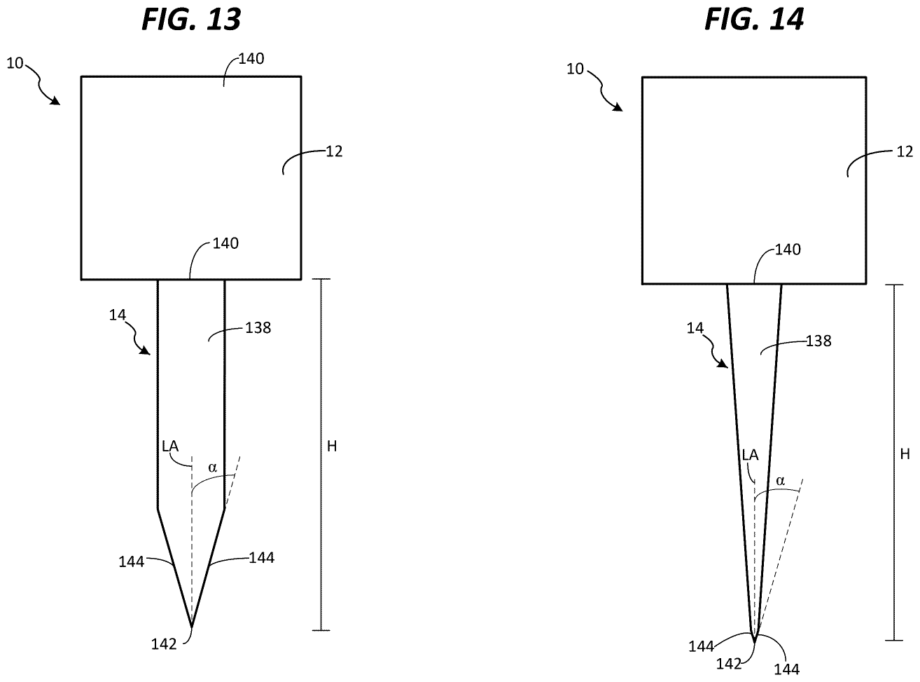

FIGS. 13-19 illustrate blade assemblies 10 having blades 14 with different blade shapes or grinds that can be used in the present methods. Generally, each blade 14 may include a blade body 138, a spine 140, a tip 142 and one or more cutting edges 144. The spine 140 is the portion of the blade 14 opposite the tip 142, which may extend from or depend from the blade support 12. Each blade 14 also includes a longitudinal axis LA that extends from the blade tip 142 towards the spine 140. Further, each blade 14 includes one or more cutting edges 144, which preferably are located at the sharpest part of the blade. Preferably, the cutting edge(s) 144 together with the blade tip 142 initiate a cut. A cutting edge 144 can be provided on one side of a blade 14 or on both sides. Each blade preferably has an edge angle α, which is an angle between the longitudinal axis and the cutting edge 144. Likewise, each blade 14 has a height H that extends from the spine 140 to the lowermost surface (typically the lowermost cutting edge 144).

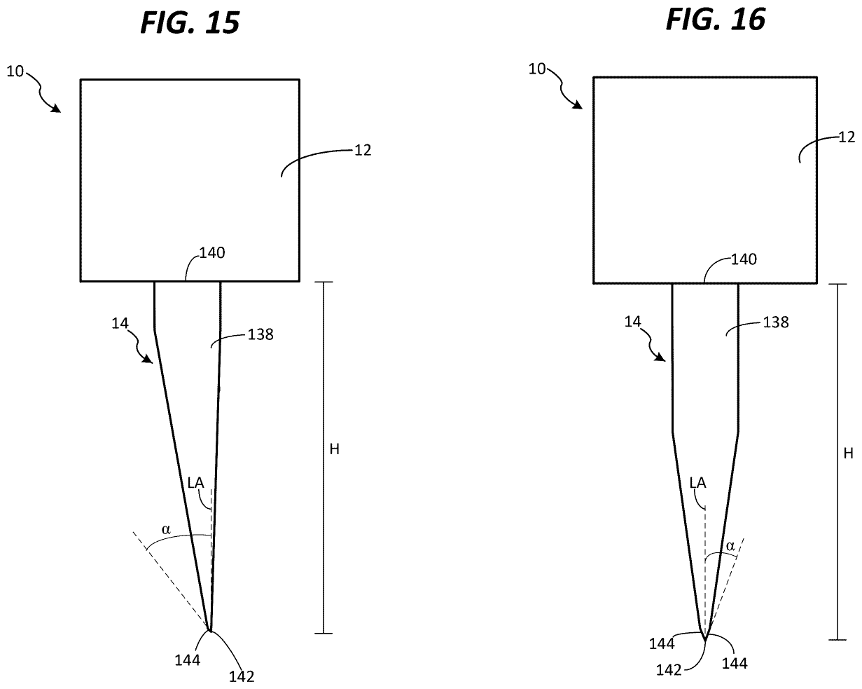

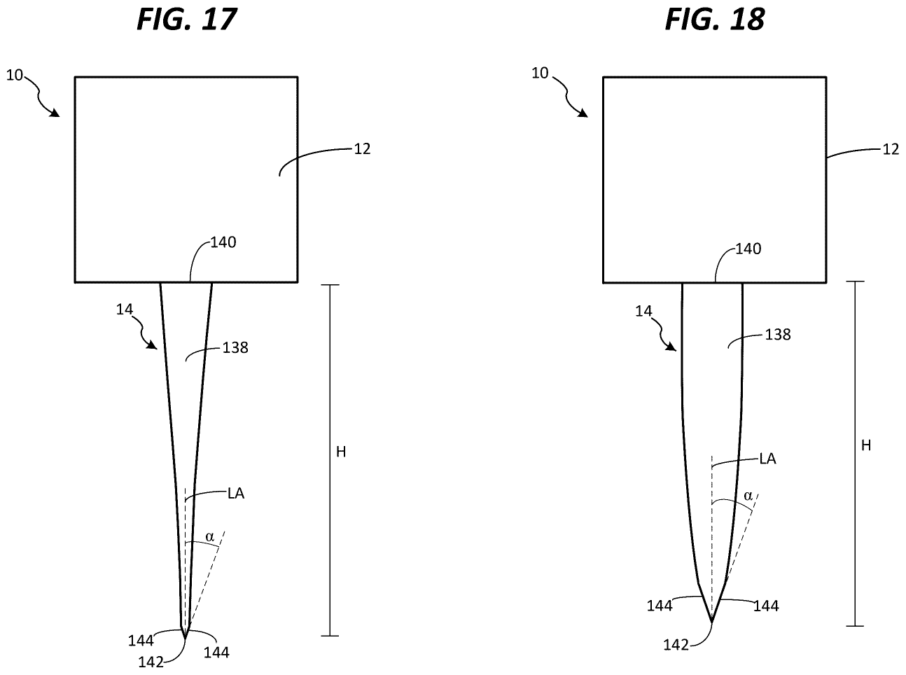

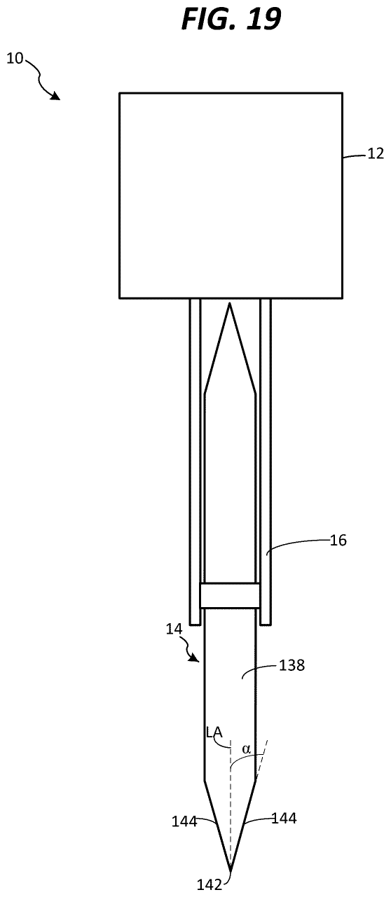

FIG. 13 illustrates a blade assembly 10 with a V-shape blade 14 that is commonly referred to as a Scandinavian grind. FIG. 14 illustrates a blade assembly 10 with a V-shaped blade 14 that is commonly referred to as a full flat grind. FIG. 15 illustrates a blade assembly 10 with a blade 14 having a shape that is commonly referred to as a chisel grind. FIG. 16 illustrates a blade assembly 10 with a blade 14 having a shape that is commonly referred to as a sabre grind. FIG. 17 illustrates a blade assembly 10 with a blade 14 having a shape that is commonly referred to as a full hollow grind. FIG. 18 illustrates a blade assembly 10 with a blade 14 having a shape that is commonly referred to as a convex grind. FIG. 19 illustrates a blade assembly 10 with circular rotating blade. In FIG. 19, a circular rotatable blade is shown with a Scandinavian grind similar to FIG. 13 but can alternatively have any desired grind such as those shown in FIGS. 14-18. It is to be appreciated that other blade configurations can be used instead of the foregoing non-limiting examples.

The selected blade 14 can include a single bevel 150, as shown in FIG. 20, or it can include a primary bevel 146 and a secondary bevel 148, as shown in FIG. 21. In FIG. 20, the single bevel 150 forms a cutting edge 144. In FIG. 21, the secondary bevel 148 forms a cutting edge 144. Further, in FIG. 20, the edge angle α is the angle between the longitudinal axis LA and the single bevel 150. In FIG. 21, the edge angle α is the angle between the longitudinal axis LA and the secondary bevel 148.

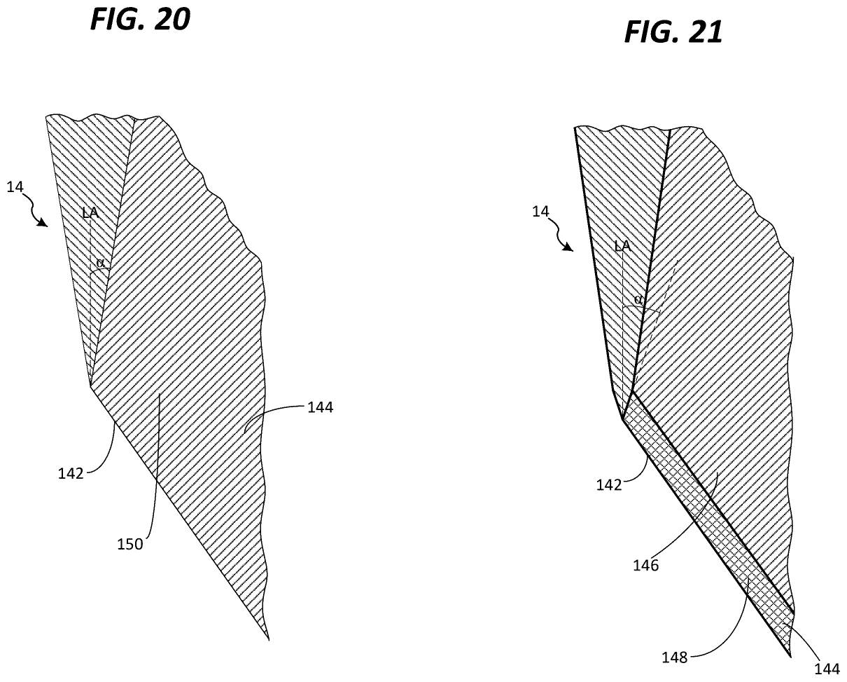

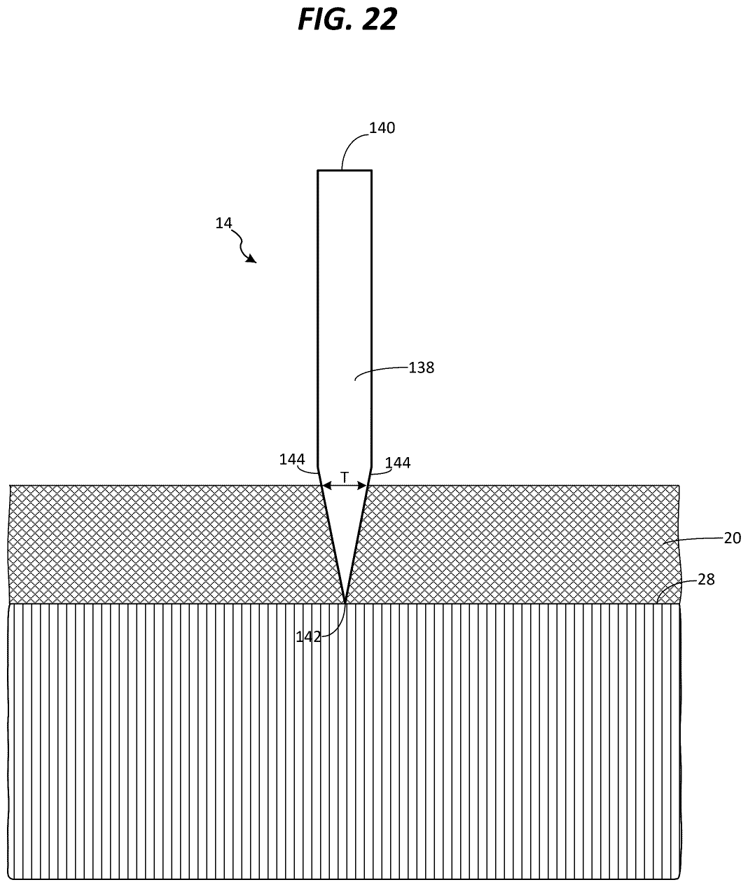

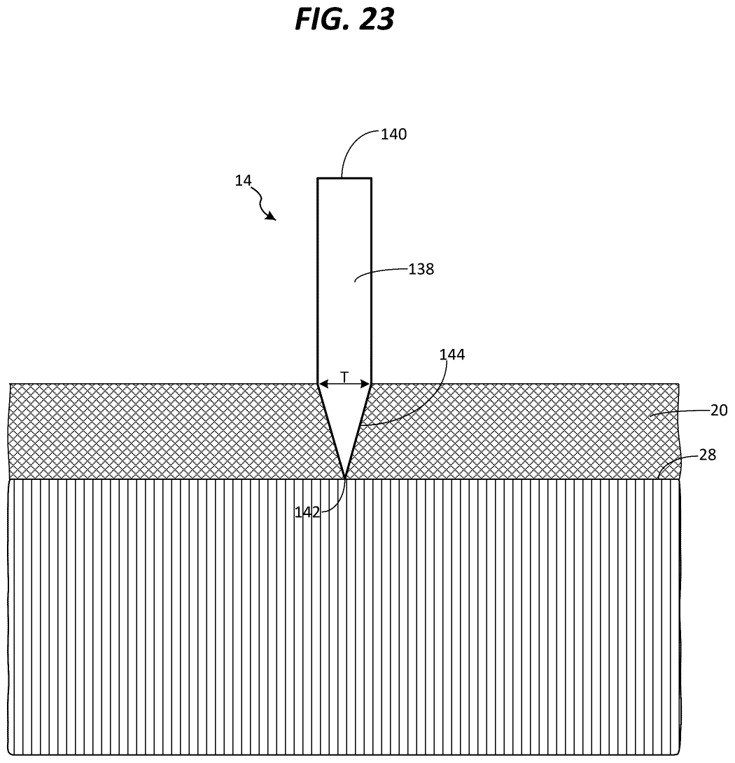

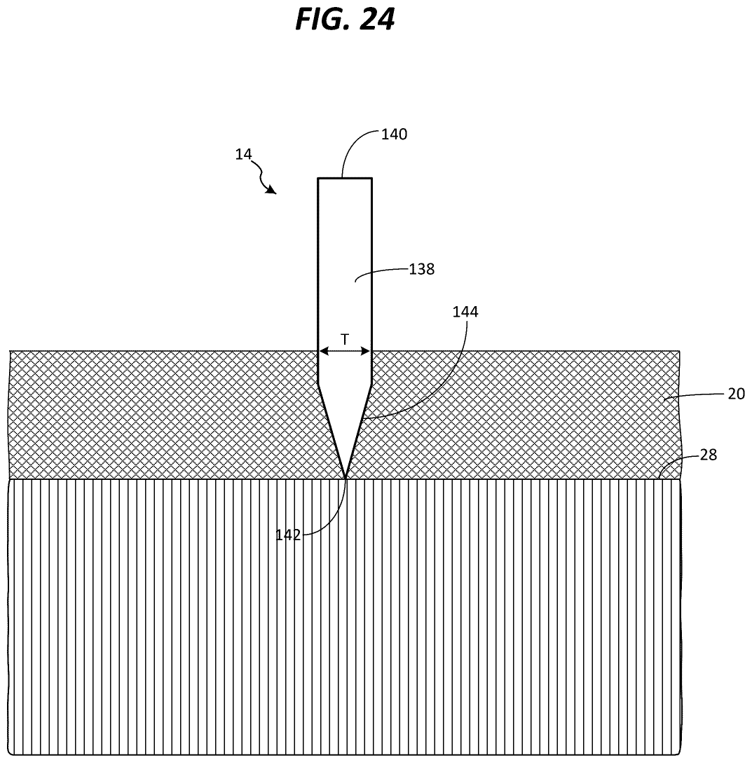

The blade 14 preferably has a small thickness. The blade thickness T is the maximum thickness of the blade 14 that penetrates the wet gel sheet 20. FIGS. 22-24 show a blade 14 penetrating a wet gel sheet 20 to different extents along the blade 14. In FIG. 22, only a portion of the cutting edges 144 penetrate the wet gel sheet 20, such that the blade thickness T is less than the thickness of the blade body 138. In FIG. 23, the blade 14 penetrates the wet gel sheet 20 such that an entirety of the cutting edges 144 is penetrating the wet gel sheet 20. In this example, the blade thickness T is equal to the thickness of the blade body 138. In FIG. 24, an entirety of the cutting edges 144 and a portion of the blade body 138 penetrate the wet gel sheet 20. Here too, the blade thickness T is equal to the thickness of the blade body 138.

Applicant has discovered that high quality cut edge faces can be obtained with a blade thickness T of 1000 microns or less, such as 900 microns or less, 800 microns or less, 700 microns or less, 600 microns or less, 500 microns or less, 400 microns or less, 300 microns or less, 200 microns or less, or 100 microns or less. In preferred cases, the blade has a thickness T of 700 microns or less. A blade thickness in this range can optionally be used in any embodiment of the present disclosure.

The blade 14 also preferably has a desired edge angle α. Applicant has discovered that an edge angle α of from 15 degrees to 30 degrees can provide high quality cut edge faces. In certain embodiments, the blade thickness T is 700 microns or less and the edge angle α is from 15 degrees to 30 degrees. In particular embodiments, the blade thickness T is 200 microns or less and the edge angle α is from 15 degrees to 25 degrees. In one preferred embodiment, the blade thickness T is 100 microns, and the edge angle α is 20 degrees.

The blade 14 can be formed of any desirable material. In some cases, the blade 14 is formed from a material selected from the group consisting of high-carbon steel, stainless steel, carbide, ceramic and/or polymer. In some cases, portions of the blade 14 can be coated with another material, such as titanium or diamond, to reduce friction and/or enhance cutting. In certain cases, the blade 14 is formed from a material that does not corrode in the presence of a specific solvent that is in at least some pores of the wet gel sheet 20. In preferred cases, the blade 14 is formed of stainless steel.

The wet gel sheet 20 is a porous material that includes solvent in at least some of its pores. In a preferred embodiment, the wet gel sheet 20 is submerged in a solution comprising (optionally consisting essentially of) solvent 32 during the cutting. In certain cases, the wet gel sheet 20 is fully submerged in the solution comprising (optionally consisting essentially of) solvent 32 during the cutting, such that the top face 22 of the wet gel sheet is beneath the surface of the solution. The solvent 32 can be any solvent discussed herein. In other cases, at least one portion of the wet gel sheet 20 is misted or sprayed with a solution comprising (optionally consisting essentially of) solvent 32 during the cutting. In many cases, the solvent 32 is a flammable solvent. In certain cases, the solvent 32 is a flammable alcohol, such as methanol, ethanol or isopropanol. In other cases, the solvent 32 is water. In even further cases, the solvent 32 is a mixture of two or more solvents, e.g., a mixture of methanol and water.

The wet gel sheet 20 can be any wet gel sheet containing a solvent within at least some pores. In some cases, the wet gel sheet 20 is an alcogel sheet and contains alcohol within at least some pores. In such cases, the alcogel sheet can be submerged (optionally fully submerged) in an alcohol. In certain cases, the wet gel sheet 20 is a silica wet gel sheet (e.g., having a silica skeleton). In some cases, the silica wet gel sheet consists essentially of silica. In specific cases, the silica wet gel sheet is a silica alcogel sheet, which during the cutting can be submerged (e.g., fully submerged) in an alcohol.

In some cases, a silica wet gel sheet is synthesized from methyl silicate (MS-51). For example, the silica wet gel sheet can optionally be synthesized from MS-51, methanol, water and ammonium hydroxide solution. In other cases, a silica wet gel sheet is synthesized from MS-51 and methyltrimethoxysilane (MTMS). For example, the silica wet gel sheet can optionally be synthesized from MS-51, MTMS, methanol, water and ammonia hydroxide. In yet other cases, a silica wet gel sheet is synthesized from MS-51 and methyltriethoxysilane (MTES). For example, the silica wet gel sheet can optionally be synthesized from MS-51, MTES, methanol, water and ammonia hydroxide.

In other cases, a silica wet gel sheet is synthesized from tetramethyl orthosilicate (TMOS). For example, the silica wet gel sheet can optionally be synthesized from TMOS, methanol, water and ammonium hydroxide. In some cases, a silica wet gel sheet is synthesized from TMOS and MTMS. For example, the silica wet gel sheet can optionally be synthesized from TMOS, MTMS, methanol, water and ammonia hydroxide. In other cases, a silica wet gel sheet is synthesized from TMOS and MTES. In such cases, the silica wet gel sheet can optionally be synthesized from TMOS, MTES, methanol, water and ammonium hydroxide.

Suitable silica wet gel sheets synthesized from these components are described in U.S. Patent Application Publication No. US20230416099, entitled “Silica Wet Gel and Aerogel Materials,” and U.S. patent application Ser. No. 18/636,553, entitled “Hydrophobic Silica Wet Gel and Aerogel,” the teachings of each which are incorporated herein by reference.

The wet gel sheet 20 is not required to be silica wet gel. Rather, any desired wet gel composition may be used. In other examples, cellulose based wet gel is used. In such cases, the wet gel sheet can be cellulose based wet gel of the type described in U.S. Pat. No. 11,180,627, entitled “Cellulose Enabled Orientationally Ordered Flexible Gels,” or U.S. Patent Application Publication No. US20190055373, entitled “Bacterial Cellulose Gels, Process for Producing and Methods of Use,” the contents of each of which are incorporated herein by reference. More generally, various biopolymer wet gels, composite silica wet gels, or other suitable wet gel compositions may be used.

The wet gel sheet 20 can have a thickness in a range of from 1.5 mm to 15 mm, such as from 2 mm to 8 mm, or from 2 mm to 4 mm (e.g., 3 mm) or perhaps from 3 mm to 5 mm. It is to be appreciated, however, that other thicknesses can be used. Also, the wet gel sheet 20 preferably is not a flexible fibrous material and/or is devoid of fibers. For example, it preferably is not a fabric or blanket embedded in a wet gel. This can optionally be the case for any embodiment of the present disclosure.

The wet gel sheet can have a plurality of uncut edge faces 26. During the cutting process, the wet gel sheet 20 is cut along one or more cut lines 40 to obtain any desired dimensions and/or configuration. The cut lines 40 are lines along which the wet gel sheet 20 is cut. The cut lines 40 generally extend along a partial or entire length or width of the wet gel sheet 20, while preferably extending through an entire thickness of the wet gel sheet 20.

The cutting methods described herein can be used to make a single cut through an entire thickness of the wet gel sheet 20 in a single pass of a single blade assembly. In other embodiments, the cutting methods can be used to first make a scoring cut (or partial cut) through a portion of the thickness of the wet gel sheet 20, e.g., starting from the top face, to provide a score 150, and then to make a second, complete cut starting with the score and cutting through the remaining thickness. In some cases, the same blade assembly is used to first make a scoring cut and then again to make a complete cut. In other cases, a first blade assembly can be used to first make a scoring cut, and then a second blade assembly can be used to make a complete cut.

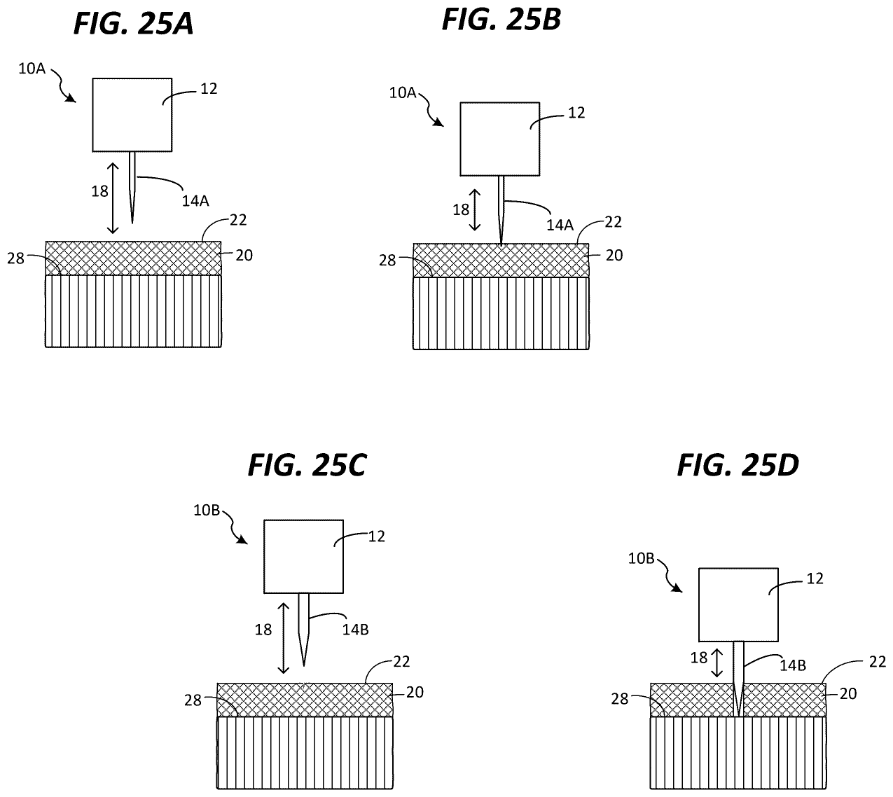

FIGS. 25A-25D illustrate an example of a method of first making a scoring cut and then making a complete cut. FIGS. 25A and 25B show a first blade assembly 10A that includes a first blade 14A, whereas FIGS. 25C and 25D show a second blade assembly 10B that includes a second blade 14B. In the illustrated embodiment, the first blade 14A is the scoring blade and the second blade 14B is a blade that makes a complete cut. As shown, in some cases, the first blade 14A has a smaller blade thickness T than the second blade 14B. In alternative embodiments, the second blade 14B may have a smaller blade thickness T than the first blade 14A.

The first blade 14A can move downward along a vertical cutting path 18 to first make a score or partial cut 152 through a portion of the wet gel sheet 20, starting from the top face 22. Next, the second blade 14B can move downward along the vertical cutting path 18 to make a complete cut, starting with the score or partial cut 152 and cutting through the remaining thickness.

The illustrated method of FIGS. 25A-25D shows two different blades assemblies 10A, 10B with different blades 14A, 14B being used, but the method can also be accomplished using a single blade assembly with a single blade. In even further embodiments, two different blade assemblies having different cutting paths can be used. For example, a first blade assembly with one cutting path (e.g., a sideways cutting path) can be used to make the scoring cut and a second blade assembly with a different cutting path (e.g., a vertical cutting path) can be used to make the complete cut. Any desired number and combination of blade assemblies, blade types and cutting path directions can be used to accomplish such a method of making a scoring cut and then making a complete cut.

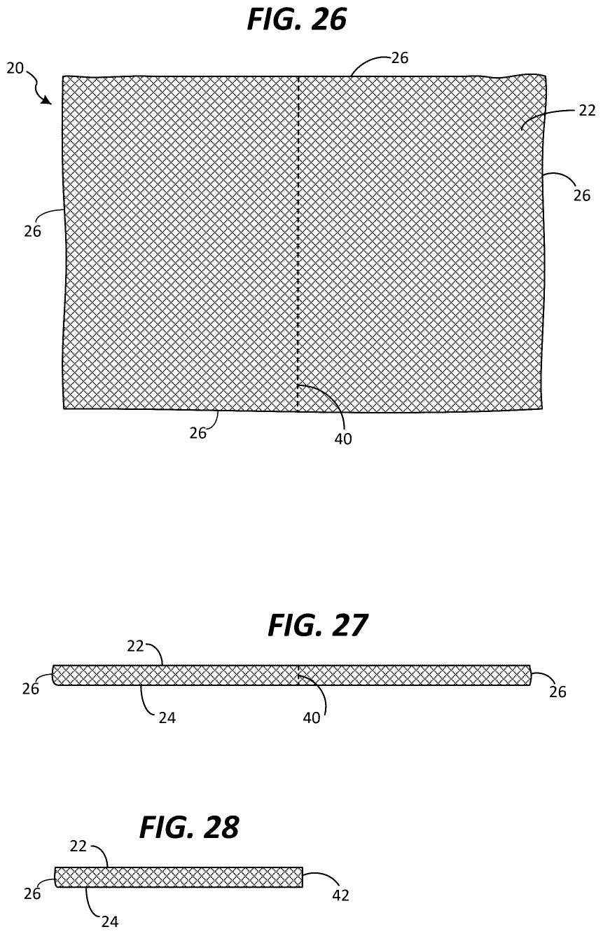

The wet gel sheet can be cut in a number of different ways. FIGS. 26-34 illustrate exemplary ways of cutting the wet gel sheet.

FIGS. 26-27 illustrate a single cut line 40 that, when cut, divides a single wet gel sheet 20 into two sheets. As shown in FIG. 28, after cutting, each sheet 20 includes a single cut edge face 42 that is preferably vertical.

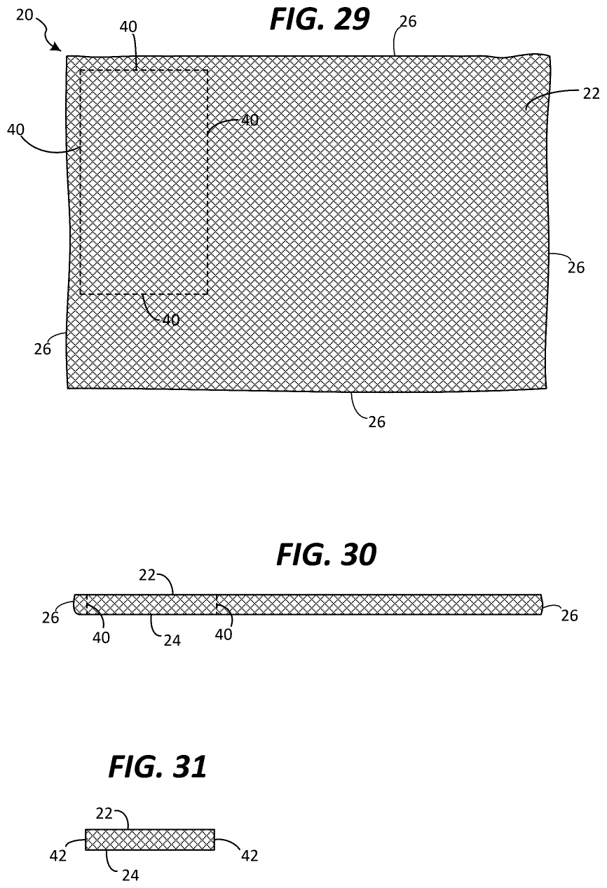

FIGS. 29-30 illustrate a plurality of cut lines 40 that collectively form a rectangular shape. In FIG. 31, after cutting, the wet gel sheet 20 has four vertical cut edge faces 42 (two of which are shown).

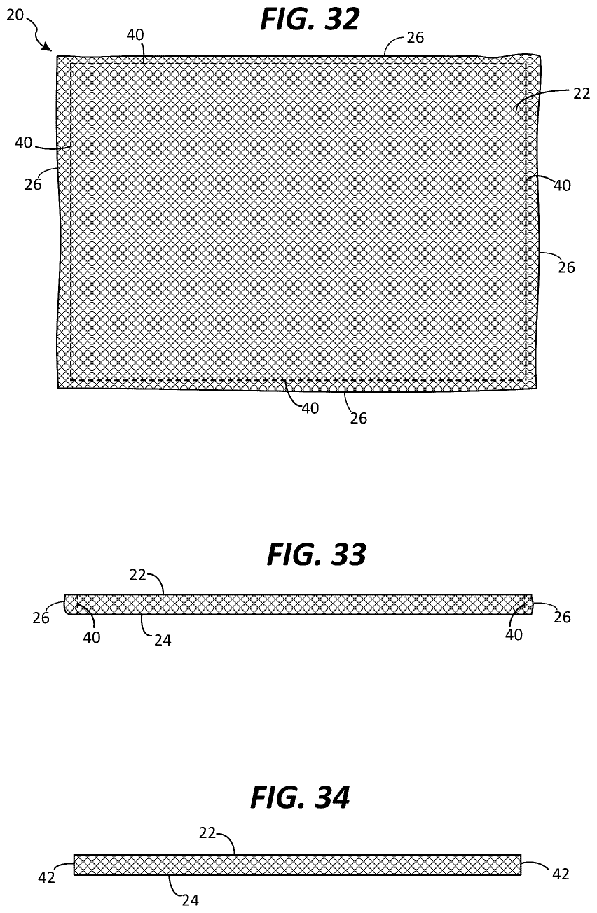

FIGS. 32-33 also illustrate a plurality of cut lines 40 that collectively form a rectangular shape. However, in FIGS. 32-33, the rectangular shape is formed along a perimeter of the wet gel sheet 20. In other words, each cut line 40 is adjacent an uncut edge face 26. As shown in FIG. 34, after cutting, the wet gel sheet has four vertical cut edge faces 42 (two of which are shown).

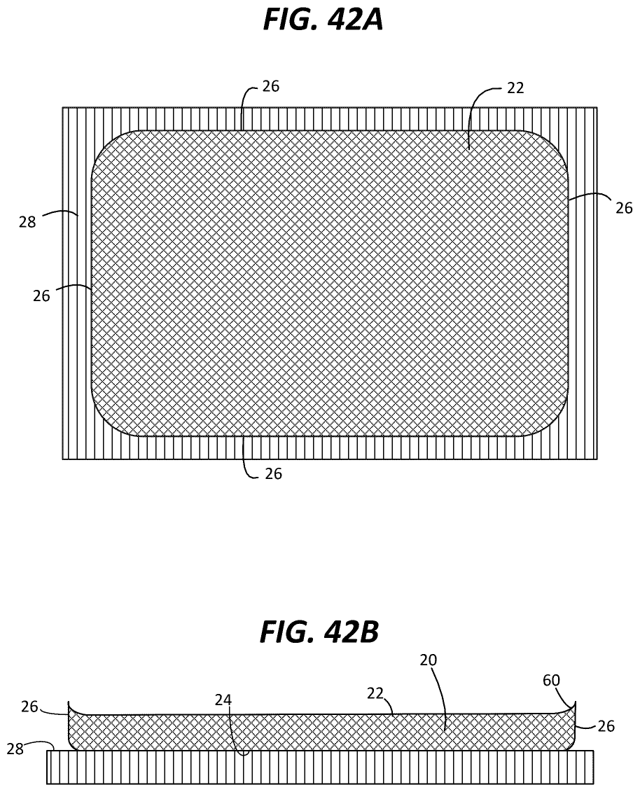

According to one or more embodiments, the edge faces 26 of a wet gel sheet 20 are removed by cutting to leave behind high quality cut edge faces 42. Preferably, the edge faces 26 are cut before drying the wet gel sheet 20. During wet gel formation, uneven surface features can develop along the perimeter of the wet gel sheet 20 and/or on the edge faces 26. For example, a meniscus 60 can sometimes form. Reference is made to the non-limiting example of FIGS. 42A-42B. Thus, it can be desirable to cut away edge faces 26 so that the wet gel sheet 20 has a uniform surface and high quality cut edge faces 42.

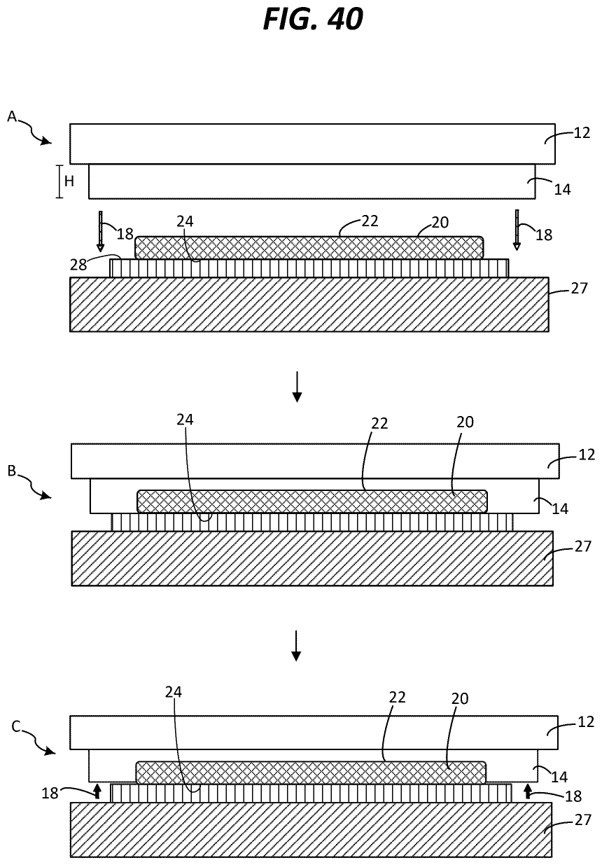

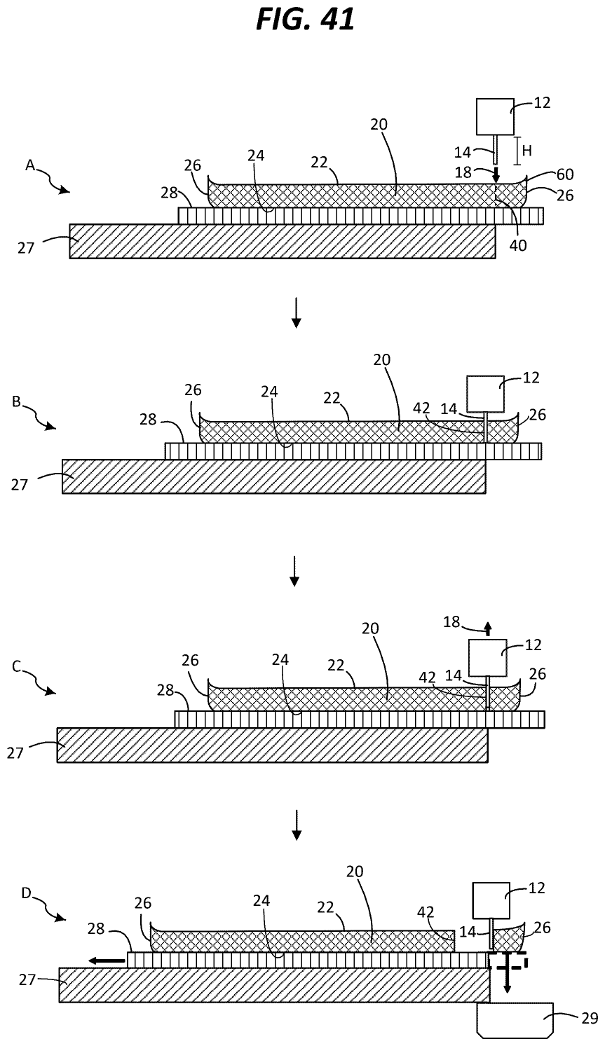

FIGS. 40-41 illustrate a blade assembly 10 cutting an edge face 26 away from a wet gel sheet 20 according to one or more embodiments described herein. The method includes providing a wet gel sheet 20 on a cutting support surface 28, so that a bottom face 24 of the wet gel sheet is supported by the cutting support surface 28 and a top face 22 of the wet gel sheet faces in an opposite direction. The cutting support surface 28 can optionally be supported by an underlying support 27. In certain cases, the underlying support 27 can be a fixed surface and the cutting support surface 28 is movable (e.g., slidable) over the underlying support 27. In certain cases, the cutting support surface 28 is a glass sheet that slides over the underlying support 27. The underlying support 27 may be a table, counter, or other support or base.

In a preferred embodiment, the wet gel sheet 20 is a porous material comprising solvent within at least some pores. In some cases, at least a portion of the wet gel sheet 20 is coated and/or wetted with a solution comprising the solvent 32 during the cutting (e.g., by being continuously misted with the solution comprising the solvent 32 during the cutting). Any known coating or misting apparatus (not shown) can be provided near the assembly 10 to perform the coating or misting.

As illustrated in the non-limiting embodiments of FIGS. 40-41, an edge face 26 of a wet gel sheet 20 is cut away to leave behind a wet gel sheet 20 having a clean cut edge 42. As shown in steps A and B of FIGS. 40-41, a blade 14 is moved along a cutting path 18 such that a cutting edge 144 of the blade moves from the top face 22 of the wet gel sheet 20 to the bottom face 24 of the wet gel sheet. Preferably, the wet gel sheet 20 is stationary during the cutting. This can optionally be the case for any embodiment of this disclosure. In some cases, the wet gel sheet 20 is adhered (e.g., lightly adhered) to the cutting support 28 during the cutting. As shown in step D of FIG. 41, the edge face 26 is removed by moving the cutting support surface 28 (with the wet gel sheet 20 and clean cut edge 42 thereon) away from the blade 14 while the blade remains stationary.

In some embodiments, the cutting support surface 28 is moved away from the blade 14 while the blade is adjacent to but not in direct contact with the bottom face 24 of the wet gel sheet 20 so as to scrape the edge face 26 away. In such cases, the blade 14 may first contact the cutting support surface 28 to fully cut through the wet gel sheet 20 (as shown in step B of FIGS. 40 and 41 and then be slightly raised away from the cutting support surface 28 (as shown in step C of FIGS. 40 and 41). This allows the cutting support surface 28 to be easily moved away from the blade 14 without the blade 14 exerting a force on (e.g., scraping) the cutting support surface 28 (as shown in step D of FIG. 41).

Once the wet gel sheet 20 is cut, it has a clean, flat edge 42 for continued processing. Preferably, the cutting support surface 28 may be moved and even rotated so that the cutting steps may be repeated to cut additional edge faces 26 of the wet gel sheet 20 as desired. In some cases, as best shown in FIG. 41, the wet gel sheet 20 and underlying cutting support surface 28 are positioned on the optionally underlying base 27 such that the edge face 26 desired to be removed is not supported by (e.g., is not directly above) the underlying base 27. In such cases, the cutting support surface 28 can moved away from the blade 14 until the edge face 26 falls away from the underlying base 27. In some cases, a receptable 29 or other container is optionally provided to receive the scrapped edge face 26. Also, in some cases, the blade 14 has a height H that is greater than a thickness of the wet gel sheet 20. Such a height H feature helps to cleanly separate the edge face 26 from the cut edge face 42. Such arrangements of parts and features described herein are desirable to help remove the edge face 26 without leaving behind debris that can undesirably be deposited onto the cut edge face 42 and/or remaining wet gel sheet 20. It is desirable that the wet gel sheet 20 be free of debris for downstream processing.

In certain embodiments, a cutting table is provided having an underlying base 27 and a blade assembly 10 thereon for cutting aerogel sheets. In such embodiments, the wet gel sheet 20 preferably is adhered (e.g., lightly adhered) to a cutting support surface 28 (e.g., a glass sheet). The cutting support surface 28 (with wet gel sheet 20 on top) is placed under a blade 14 and the blade cuts down to the cutting support surface 28. A user and/or automated system then pulls the cutting support surface 28 while the blade 14 is adjacent the wet gel sheet 20 so that an edge face 26 is discarded. The blade 14 removes the scrapped edge face 26 before being lifted again. By having the blade 14 do the cleaning/scraping, one does not need to use a separate tool to clean the debris away from a clean cut edge 42.

In one or more embodiments described herein, a portion of the wet gel sheet 20 is coated and/or otherwise wetted with a solution comprising the solvent 32 during the cutting, e.g., the portion of the wet gel sheet can optionally be continuously misted with the solution. The portion of the wet gel sheet 20 can include areas of the top face or the entire top face. For example, the solvent 32 can optionally be applied to the surface 22 of the wet gel once the top surface is exposed to air. The solvent 32 can be dispensed onto the surface 22 and edges 26 of the wet gel sheet as desired throughout the cutting process e.g., to prevent the wet gel sheet from cracking or drying out. Alternatively, the wet gel sheet 20 can be submerged in the solution comprising the solvent 32 before and/or during the cutting.

The cutting preferably only involves the blade 14 moving along the cutting path 18, is devoid of using any second blade, and is devoid of using any laser. In some embodiments, the blade 14 is elongated so as to extend entirely across a width or a length of the wet gel sheet 20 during the cutting. In the embodiment illustrated in the non-limiting example of FIGS. 40 and 41, the blade 14 is elongated so as to extend beyond the width or the length of the wet gel sheet 20 during the cutting. This can optionally be the case for any embodiment of this disclosure where a blade simply moves toward the cutting support surface 28 to cut the wet gel sheet 20.

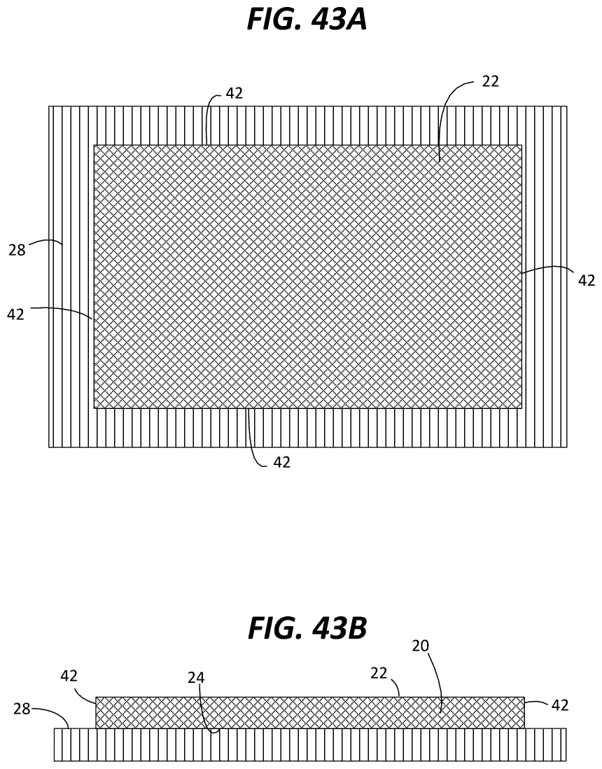

FIGS. 42A-42B illustrate a wet gel sheet 20 having uncut edge faces 26 according to one or more embodiments described herein. During wet gel formation, surface and/or edge features (e.g., a meniscus) may develop. It is often desirable to trim the wet gel sheet to remove undesirable edge features and to provide vertical cut edge faces 42. FIGS. 43A-43B illustrate a wet gel sheet 20 having four cut edge faces 42 according to one or more embodiments described herein. Here, the illustrated wet gel sheet has a rectangular configuration, as can optionally be the case in any other embodiment of this disclosure.

Each cut edge face 42 is preferably devoid of cracks or other damage visible to the naked eye, even after drying. Also, while exemplary cut lines 40 have been shown, skilled artisans will understand that any number of cut lines forming any desired dimensions and/or configuration can be provided. Further, while FIGS. 26-34 and 40-43B show the cut edge faces 42 as being vertical, which is preferred, the edge faces 42 can instead have a non-orthogonal cut, if desired. Additionally, while FIGS. 26-34 illustrate wet gel sheets 20 having uncut edge faces 26, skilled artisans will understand that the cutting methods described herein can also be performed on wet gel sheets 20 that already have some cut edge faces. Once a wet gel sheet 20 is cut as desired, it can be dried to form an aerogel sheet using any suitable aerogel drying method.

The cutting method preferably does not remove any chemical component from the wet gel sheet or otherwise change a chemical composition of the wet gel sheet. For example, if the wet gel sheet has a hydrophobic composition, the cutting method preferably does not reduce or eliminate hydrophobicity along the cut edge face 42 or elsewhere.

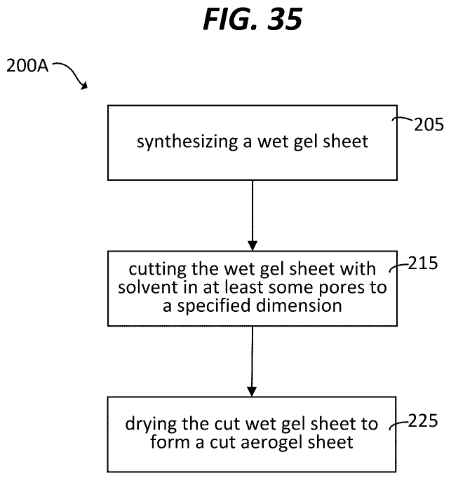

FIG. 35 illustrates a method 200A of producing aerogel sheet. The method includes a step 205 of synthesizing a wet gel sheet, a step 215 of cutting the wet gel sheet with solvent in at least some pores to a specified dimension, and a step 225 of drying the cut wet gel sheet to form a cut aerogel sheet.

In step 205, the wet gel sheet can be synthesized using any suitable method. In some cases, step 205 can be performed as disclosed in U.S. Patent Application Publication No. US20230416099, entitled “Silica Wet Gel and Aerogel Materials,” or U.S. patent application Ser. No. 18/636,553, entitled “Hydrophobic Silica Wet Gel and Aerogel,” the teachings of each which are incorporated herein by reference.

Additional steps can be provided before or after the illustrated steps. For example, in one embodiment, the method includes the step 205 of synthesizing a wet gel sheet and then a step of aging the wet gel sheet. In some cases, the cutting step 215 can be performed after the aging step is completed. In other cases, the cutting step 215 can be performed before the aging step is completed. For example, in some cases, the method includes the step 205 of synthesizing a wet gel sheet, beginning aging of the wet gel sheet, performing the cutting step 215 and then completing the aging of the wet gel sheet. In such cases, some aging of the wet gel sheet is performed both before and after cutting the wet gel sheet. Without wishing to be bound by a particular technical explanation, it is surmised that by cutting the wet gel sheet before it is completely aged, the remainder of the aging process can help further strengthen and optimize the cut edge faces. Thus, for any embodiment of this disclosure that involves aging the wet gel sheet, at least some of the aging can optionally be performed after the cutting. In certain cases, the wet gel sheet is synthesized and aged within a mold, and the cutting step 215 is also performed within the mold. In some cases, the aging step is performed by simply keeping the wet gel sheet inside a mold, which is preferably airtight. In other cases, the aging step can be performed by keeping the wet gel sheet in an aging solution.

Preferably, the method includes the step 205 of synthesizing a wet gel sheet and then subjecting the wet gel sheet to a solvent exchange. The cutting step 215 takes place with solvent from the solvent exchange in at least some pores of the wet gel sheet. In certain cases, the wet gel sheet can optionally be subjected to another solvent exchange after the cutting step 215. Such solvent exchange steps can be performed using any suitable solvent exchange method and solvent material. Generally, the wet gel sheet is subjected to a solvent for a period of time so that water in the pores is replaced with the solvent. In many cases, the wet gel sheet is placed in a solvent bath to perform the solvent exchange. When a subsequent solvent exchange step is used, the cut wet gel sheet can be returned to the original solvent bath or placed in a new solvent bath.

The cutting step 215 can be performed using any embodiment of the cutting method described herein. If the solvent exchange step is not performed, the wet gel sheet can contain water as the solvent (or solvent from an aging solution) in its pores during the cutting step 215. If the solvent exchange step is performed, water initially inside the wet gel sheet is replaced with a suitable solvent. In such cases, during the cutting step 215, the wet gel sheet contains another solvent (that is not water) in its pores. In many cases, the cutting step 215 occurs after a solvent exchange has taken place. Also, in many cases, the cutting step 215 takes place while at least portions of the wet gel sheet are being coated or otherwise actively wetted with solvent.

In some embodiments, the method also includes a separating step of removing one or more scrapped portions of the cut wet gel sheet after the cutting step 215. In many cases, the separating step uses the cutting blade to help separate the scrapped portions from the cut wet gel sheet. This can optionally be the case for any embodiment of the present disclosure. The separating step can be performed using any separating methods described herein.

Step 225 involves drying the cut wet gel sheet to form a cut aerogel sheet. Any conventional aerogel drying method can be used. In many cases, the cut wet gel sheet is placed in either a freeze dryer, a supercritical dryer, or an ambient dryer. In such cases, the step 225 of drying the cut wet gel sheet comprises a freeze-drying process, a supercritical drying process, or an ambient drying process.

In some cases, the cut wet gel sheet is dried using a supercritical drying method (also known as a critical point drying method). As is well-known to skilled artisans, supercritical drying involves a solvent exchange. Specifically, the water initially inside the wet gel sheet is replaced with a suitable organic solvent (e.g., methanol, ethanol, or acetone). The cut wet gel sheet is later placed in a pressure vessel along with liquid carbon dioxide. The pressure vessel may be filled with, and emptied of, liquid carbon dioxide multiple times, so as to remove the organic solvent and leave liquid carbon dioxide in its place. The liquid carbon dioxide is then heated past its critical temperature and pressure and removed, thereby leaving a cut aerogel sheet.

In other cases, the cut wet gel sheet is dried using an ambient drying method. As used herein, ambient drying involves drying the cut wet gel sheet under ambient conditions (e.g., at a temperature in a range of from about 50 degrees to about 85 degrees Fahrenheit, and more typically in a range of from 68 degrees to 72 degrees Fahrenheit). The liquid in the cut wet gel sheet is allowed to slowly evaporate under controlled conditions, leaving a cut aerogel sheet. The controlled conditions ensure that the evaporation is slow enough that the gel network does not collapse during the drying. With ambient drying, the dryer is configured to establish a controlled environment in its interior. This may involve a controlled temperature, a controlled pressure, a controlled airflow, a controlled humidity, or any combination thereof.

In still other cases, the cut wet gel sheet is dried using a freeze-drying method. The cut wet gel sheet is frozen and then put into a vacuum chamber. The solvent is then removed to leave a cut aerogel sheet. Any suitable aerogel freeze-drying technique known in the art may be used. As non-limiting examples, the cut wet gel sheet can be placed into a household freezer, liquid nitrogen, or in a cryogenic mixture (e.g., a dry-ice/solvent mixture, such as a dry-ice and acetone bath).

Other fabrication techniques can be used, such as a rapid supercritical extraction technique. Reference is made to U.S. Pat. No. 8,080,591, the salient teachings of which are incorporated herein by reference.

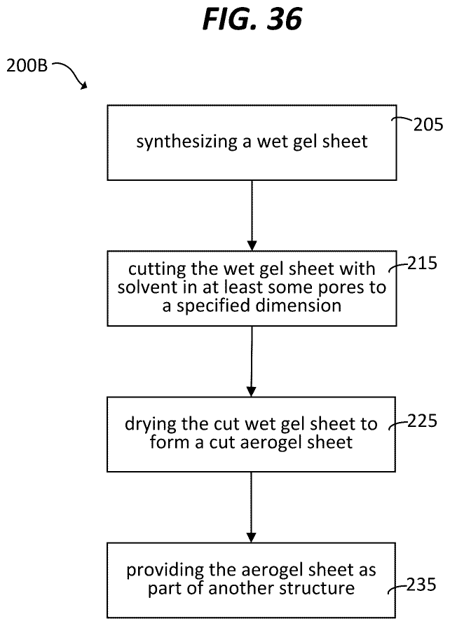

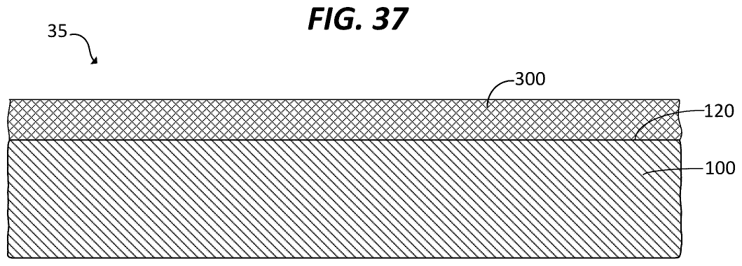

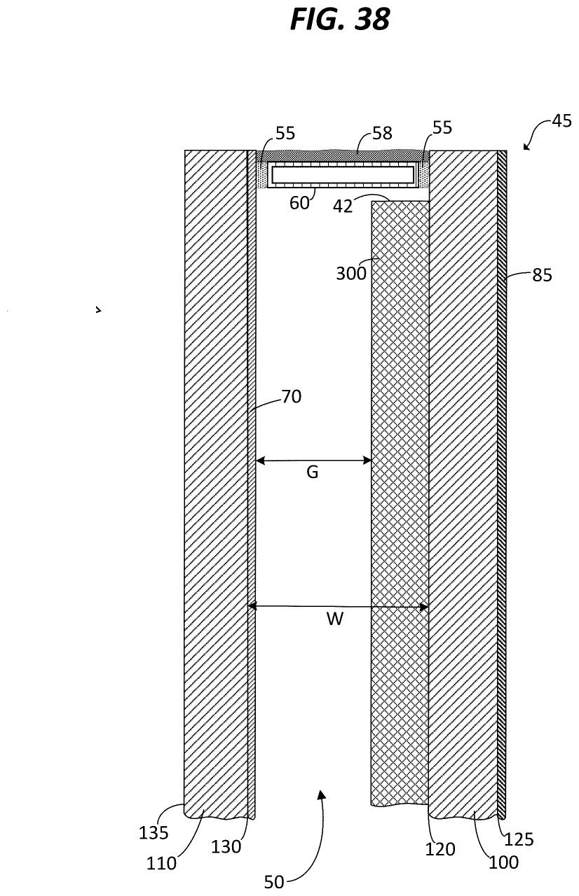

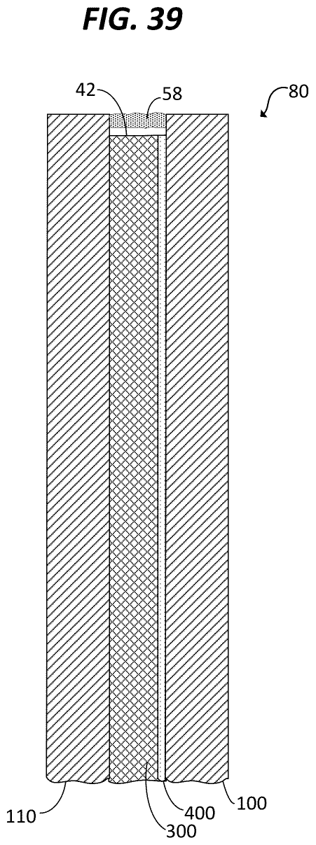

FIG. 36 illustrates a method 200B of producing an aerogel sheet that includes each step of method 200A and further includes a step 235 of providing the aerogel sheet 300 as part of another structure. In some cases, the step 235 can include mounting the aerogel sheet 300 alongside a glass sheet 100 to form a glass article 35. One such glass article example is shown in FIG. 37. If desired, the step 235 can include providing the aerogel sheet 300 in a between-pane space of an insulating glazing unit 45. One such IG unit example is shown in FIG. 38. In other cases, the step 235 can include providing the aerogel sheet 300 between two glass panes 100,110 to form a laminated glazing assembly 80. One such laminated glazing assembly 80 example is shown in FIG. 39.

The cut aerogel sheet preferably is self-supporting, i.e., once fully synthesized, formed, and cut, the sheet can retain sheet form without being adhered to glass or another support. In many cases, the cut aerogel sheet is a cut silica aerogel sheet. The cut aerogel sheet can be a transparent, brittle aerogel sheet. Thus, the cut aerogel sheet may be sufficiently rigid that it cannot be wound. In some cases, the wet gel sheet is not wound before or after the cutting. This can optionally be the case for any embodiment of this disclosure. Similarly, any such method preferably does not include rolling or unrolling the wet gel sheet or any component thereof.

The cut aerogel sheet can also have a major dimension (e.g., a length or width) of at least 0.375 meter, for example, at least 0.6 meter, at least 0.7 meter, 0.75 meter, 0.8 meter, 0.85 meter, 0.9 meter, 0.95 meter, 1.0 meter, or in some cases at least 1.125 meters or 1.25 meters. In certain embodiments, the cut aerogel sheet has a major dimension of between 0.7 meter and 3 meters. In specific embodiments, the cut aerogel sheet has a major dimension of at least 0.9 meter.

The cut aerogel sheet has an advantageous combination of properties. First, the cut aerogel sheet desirably has low haze. For any embodiment involving a cut aerogel sheet, the haze can optionally be less than or equal to 4%, such as less than or equal to 3%, e.g., less than or equal to 2.5%, less than or equal to 2%, or less than or equal to 1.75%. In some cases, the cut aerogel sheet has a haze of less than or equal to 1.5%, less than or equal to 1.25%, or even less than or equal to 1%. This preferably is the case for any embodiment involving a cut aerogel sheet. Haze can be measured in well-known fashion, e.g., using a BYK Haze-Gard plus instrument. Reference is made to ASTM D 1003-00: Standard Test method for Haze and Luminous Transmittance of Transparent Plastics, the contents of which are incorporated herein by reference.

The cut aerogel sheet desirably also has high visible transmission. In some cases, the cut aerogel sheet has a visible transmission of at least 95%, at least 97.8%, at least 97.9%, at least 98%, at least 98.1%, at least 98.2%, at least 98.3%, at least 98.4%, at least 98.5%, at least 98.6%, at least 98.7%, at least 98.8%, at least 98.9%, or at least 99%, such as at least 99.1%, at least 99.2%, at least 99.3%, at least 99.4%, or perhaps at least 99.5%. The term “visible transmission” is well known in the art and is used herein in accordance with its well-known meaning to refer to the percentage of all incident visible radiation that is transmitted through an object (e.g., through the cut aerogel sheet). Visible radiation constitutes the wavelength range of between about 380 nm and about 780 nm. Visible transmission can be determined in accordance with NFRC 300-2017, Standard Test Method for Determining the Solar and Infrared Optical Properties of Glazing Materials and Fading Resistance of Systems. The well-known and commercially available LBNL WINDOW 7.4 computer program can be used in calculating these and other reported optical properties. The cut aerogel sheet can advantageously have both haze and visible transmission properties in any combination of the above-noted ranges for haze and visible transmission.

The cut aerogel sheet can optionally also have desirable transmitted color characterized by “a” and “b” color coordinates that are each between −2 and 2. The present discussion of color properties is reported using the well-known color coordinates of “a” and “b.” In more detail, the color coordinates are indicated herein using the subscript h (i.e., an and bh) to represent the conventional use of the well-known Hunter Lab Color System (Hunter methods/units, Ill. D65, 10 degree observer). The present color properties can be calculated as specified in “Insight on Color,” “Hunter L, a, b Color Scale,” Applications Note, Vol. 8, No. 9, 06/08 (2008), the relevant teachings of which are incorporated herein by reference.

In addition, the cut aerogel sheet can have a low bulk density. In certain embodiments, the cut aerogel sheet has a bulk density of 200 mg/cc or less. In some cases, the cut aerogel sheet has a bulk density of 150 mg/cc or less, such as 140 mg/cc or less, 130 mg/cc or less, or 125 mg/cc or less. In certain embodiments, the cut aerogel sheet also has a bulk density of at least 70 mg/cc. In some cases, the cut aerogel sheet has a bulk density of at least 80 mg/cc, such as at least 85 mg/cc or at least 95 mg/cc. In preferred embodiments, the cut aerogel sheet has a bulk density of between 100 mg/cc and 150 mg/cc, such as between 120 mg/cc and 150 mg/cc. In certain cases, the bulk density is 120 mg/cc. The density of the cut aerogel sheet can optionally be in one or more (optionally all) of the foregoing ranges for any embodiment of the present disclosure, preferably in combination with visible transmission and haze levels in any combination of the ranges noted above (e.g., Tᵥᵢₛ of at least 97.8%, at least 98%, at least 98.6% or at least 99%, together with a haze of 3% or less, 2% or less, 1.75% or less, or 1.5% or less). Bulk density can be determined by weighing the cut aerogel sheet and then calculating the volume using the dimensions of the cut aerogel sheet.

The cut aerogel sheet can also have low thermal conductivity. For example, the cut aerogel sheet can have a thermal conductivity of 14 mW/m*K or less in air, such as 13.5 mW/m*K or less, 13 mW/m*K or less, 12 mW/m*K or less, or 11.5 mW/m*K or less. Furthermore, the cut aerogel sheet can have a thermal conductivity of 10 mW/m*K or less in an inert gas, such as argon. The thermal conductivity of the cut aerogel sheet can optionally be in one or more (optionally all) of these ranges for any embodiment of the present disclosure. Thermal conductivity can be determined using a conventional heat flow meter, such as the well-known TA Instruments Fox 200 heat flow meter, which is commercially available from Waters Corporation (New Castle, Delaware, U.S.A.).

Further, the cut aerogel sheet can have a flexural modulus of 6000 kPa or less, such as 4500 kPa or less, 2400 kPa or less, 2300 kPa or less, 2000 kPa or less, 1900 kPa or less, 1800 kPa or less, 1700 kPa or less, 1600 kPa or less, 1500 kPa or less, 1400 kPa or less, 1300 kPa or less, 1200 kPa or less, 1100 kPa or less, 1000 kPa or less, 900 kPa or less, 800 kPa or less, 750 kPa or less, or even 700 kPa or less. In some cases, the cut aerogel sheet can have a flexural modulus of between 700 kPa and 6000 kPa, such as between 750 kPa and 6000 kPa, between 800 kPa and 6000 kPa, between 900 kPa and 6000 kPa, between 1000 kPa and 6000 kPa, between 1100 kPa and 6000 kPa, between 1200 kPa and 6000 kPa, between 1300 kPa and 6000 kPa, between 1400 kPa and 6000 kPa, between 1500 kPa and 6000 kPa, between 1600 kPa and 6000 kPa, between 1700 kPa and 6000 kPa, between 1800 kPa and 6000 kPa, between 1900 kPa and 6000 kPa, between 2000 kPa and 6000 kPa, between 2300 kPa and 6000 kPa or between 2400 kPa and 6000 kPa.

The flexural modulus of a material is a mechanical property that measures the material's stiffness or resistance to bending and is defined as the ratio of stress to strain in flexural deformation. It is determined from the slope of a stress-strain curve produced by a flexural test, such as ASTM D790: Standard Test Methods for Flexural Properties of Unreinforced and Reinforced Plastics and Electrical Insulating Material, the contents of which are incorporated herein by reference. The higher the flexural modulus of a material, the harder it is to bend. Conversely, the lower the flexural modulus, the easier it is for the material to bend under an applied force.

The cut aerogel sheet can have an average pore size of 31 nm or less, such as 30 nm or less, 29 nm or less, 28 nm or less, 27 nm or less, 26 nm or less, 25 nm or less, 24 nm or less, 23 nm or less, 22 nm or less, 21 nm or less, or even 20 nm or less. This can optionally be the case for any embodiment of the present disclosure that involves the cut aerogel sheet. The average pore size can be determined using a Quantachrome “autosorb-iQ” gas absorption analyzer, which is commercially available from Anton Paar (Graz, Austria) along with calculating average pore size using density functional theory (DFT) calculations.

The cut aerogel sheet can also have a specific surface area of at least 750 m²/g, such as at least 800 m²/g, at least 850 m²/g, at least 900 m²/g, at least 950 m²/g, or at least 1000 m²/g. This can optionally be the case for any embodiment of the present disclosure that involves the cut aerogel sheet, preferably in combination with an average pore size in one or more (optionally all) of the ranges noted in the paragraph above and/or in combination with a density of between 100 mg/cc and 150 mg/cc, optionally in further combination with visible transmission and haze levels in any combination of the ranges noted above (e.g., Tᵥᵢₛ of at least 97.8%, perhaps at least 98%, at least 98.6%, or at least 99%, together with haze of 3% or less, 2% or less, 1.75% or less, or 1.5% or less). The specific surface area can be determined using a Quantachrome “autosorb-iQ” gas absorption analyzer, which is commercially available from Anton Paar (Graz, Austria) along with calculating specific surface area using density functional theory (DFT) calculations.

Some embodiments provide an article comprising a cut aerogel sheet 300 formed by any process described herein. The article is not limited to window and other glazing applications, but rather can be any article designed to provide thermal insulation. For example, the cut aerogel sheet 300 can be provided on articles such as glass, solar panels, vehicle roofs, walls of refrigerated trucks, walls of buildings and more.

FIG. 37 illustrates an article 35 comprising a glass sheet 100 and a cut aerogel sheet 300. The cut aerogel sheet 300 is adhered to or otherwise carried or mounted alongside the glass sheet 100. The cut aerogel sheet 300 can have any of the features and properties discussed herein. Thus, the cut aerogel sheet 300 has one or more cut edge faces 42 formed by any process described herein.

The cut aerogel sheet 300 preferably is adhered to a surface 120 of the glass sheet 100. By saying the cut aerogel sheet 300 is “adhered to” a surface of a glass sheet, this does not require a separate adhesive, though an adhesive can optionally be used. It also does not require the cut aerogel sheet 300 to contact the glass; there may be a coating or layer therebetween. Thus, although “adhered to” may involve direct contact, the broader meaning as used herein is “carried alongside.” This can optionally mean the cut aerogel sheet 300 is supported by the glass surface, and in some preferred embodiments the cut aerogel sheet 300 does contact the glass surface. In certain embodiments, there is at most one layer (e.g., an optical adhesive layer) between the cut aerogel sheet 300 and the glass sheet 100. In some cases, the cut aerogel sheet 300 adheres to the glass sheet directly through van der Waals forces. In other cases, the cut aerogel sheet 300 adheres to a glass sheet by an optical adhesive, optionally such that certain portions of the cut aerogel sheet are devoid of the optical adhesive. In embodiments of this nature, the optical adhesive can be located at a perimeter of the cut aerogel sheet 300.

A variety of known glass types can be used for the glass sheet 100, including soda-lime glass, borosilicate glass or aluminosilicate glass. In some cases, it may be desirable to use “white glass,” a low iron glass, etc. For some applications, it may be desirable to use tinted glass for the glass sheet 100. Moreover, there may be applications where the glass sheet 100 is formed of extremely thin, flexible glass, such as glass sold under the trademark Willow glass by Corning Inc. (Corning, New York, U.S.A.). If desired, the glass sheet 100 may be formed of a chemically strengthened glass, such as glass sold under the trademark Gorilla glass by Corning Inc. In certain embodiments, the glass sheet is part of a window, door, skylight, or other glazing. In any such embodiments, the article 35 is part of a multiple-pane insulating glazing unit. Reference is made to the non-limiting example of FIG. 38, where one or both panes 100, 110 preferably are formed of glass. In some cases, the glass sheet is part of a window insert or interior window designed to be retrofitted to an inside of an existing window. Exemplary window inserts are sold as Indow Inserts (Indow, Oregon, U.S.A.) or ComfortSEAL Interior Windows (Larson Manufacturing, South Dakota, U.S.A.). In alternative embodiments, the glass sheet 100 is replaced with a sheet formed of a polymer, such as polycarbonate, acrylic, or PVC. Various other polymer materials (e.g., transparent polymers) may be used in such alternative embodiments.

Glass sheets of various sizes can be used. Commonly, large-area glass sheets are used. For example, the glass sheet 100 can have a major dimension (e.g., a length or width) of at least about 0.1 meter, preferably at least 0.5 meter, such as at least 0.6 meter, more preferably at least 1 meter, or at least 1.5 meters (e.g., between 2 meters and 4 meters).

Glass sheets of various thicknesses can be used. In some embodiments, the glass sheet 100 can have a thickness of about 1-8 mm. In some cases, the glass sheet 100 has a thickness of between about 2.3 mm and about 4.8 mm, and more preferably between about 2.5 mm and about 4.8 mm. In one particular embodiment, the glass sheet 100 has a thickness of about 3 mm.

Some embodiments provide an insulating glazing unit. FIG. 38 illustrates an insulating glazing unit 45 according to certain embodiments comprising a first glass sheet 100, a second glass sheet 110, and a between-pane space 50. The between-pane space 50 is located between the two glass sheets. The glass sheets 100, 110 can have any of the features, compositions, and dimensions described for a glass sheet elsewhere herein. In alternative embodiments, one or both glass sheets 100, 110 are replaced with sheets formed of a polymer, such as polycarbonate. Various other polymer materials may be used in such alternative embodiments. The insulating glazing unit further comprises a cut aerogel sheet 300 within the between-pane space 50. The cut aerogel sheet 300 can have any of the features and properties described elsewhere herein.

In some cases, the cut aerogel sheet 300 is a single aerogel sheet. In such cases, there is only one aerogel sheet 300 in the between-pane space 50. There may be, for example, a single cut aerogel sheet 300 in a between-pane space of an IG unit 45, and such an aerogel sheet may include four cut edge faces 42. The single aerogel sheet 300 can, for example, have a major dimension (e.g., a length or width) of at least 0.375 meter, e.g., at least about 0.6 meter, 0.7 meter, 0.75 meter, 0.8 meter, 0.85 meter, 0.9 meter, 0.95 meter, 1.0 meter, or in some cases at least about 1.125 meters or 1.25 meters. In certain embodiments, the cut aerogel sheet 300 has a major dimension of between 0.7 meter and 3 meters. In specific embodiments, the cut aerogel sheet 30 has a major dimension of at least 0.6 meter.

In other cases, a plurality of cut aerogel sheets are provided. In such cases, there are a plurality of cut aerogel sheets in the between-pane space 50. When multiple cut aerogel sheets are used, they can be arranged in a tiled configuration between the two glass sheets 100, 110. When a tiled configuration is used, multiple cut aerogel sheets preferably are arranged in a non-overlapping manner so as to cover a majority (i.e., greater than 50%, preferably at least 75%) of the area of an adjacent interior glass surface 120 or 130.

Whether one or multiple cut aerogel sheets are used, it or they preferably cover more than 60% (e.g., more than 70%, more than 80%, or even more than 90%) of an adjacent interior glass surface 120 or 130. A coverage within any one or more (e.g., all) of these ranges can optionally be used in any embodiment of the present disclosure.

When the cut aerogel sheet 300 comprises a plurality of cut aerogel sheets, those sheets can have any desired shape and tiling arrangement. As non-limiting examples, the cut aerogel sheets can be square, rectangular, or hexagonal in shape. In some embodiments, the cut edge faces of each cut aerogel sheet are aligned both vertically and horizontally with edges of adjacent aerogel sheets. Reference is made to U.S. patent application Ser. No. 17/390,178, the teachings of which relating to aerogel sheet tiling arrangements are hereby incorporated by reference.

In certain embodiments, the between-pane space 50 contains a gaseous atmosphere, preferably comprising a thermally insulative gas, such as argon, krypton, or both. In some cases, the gaseous atmosphere comprises a mix of argon and air (e.g., 90% argon and 10% air). In other cases, the gaseous atmosphere comprises a mix of krypton and air. In still other cases, the gaseous atmosphere comprises a mix of argon, krypton, and air. In yet other cases, the gaseous atmosphere is just air.

In certain cases, a gas gap G is provided in the between-pane space 50 alongside the cut aerogel sheet 300. In some cases, the gas gap G has a width in a range of from 9 to 14 mm and it contains a gaseous atmosphere comprising argon, air, or both. In certain cases, the between-pane space has a width W in a range of from 14 to 21 mm, the gaseous atmosphere comprises argon, and the width of the gas gap G is from 10.5 to 13.5 mm. Reference is made to U.S. patent application Ser. No. 17/389,603, the teachings of which relating to gas gap and between-pane space configurations are hereby incorporated by reference.

Certain embodiments include a spacer 60 between the two glass sheets 100, 110. The spacer 60 may be a conventional metal channel spacer, e.g., formed of stainless steel or aluminum. Or it can comprise polymer and metal, or just polymer (e.g., foam). The spacer can alternatively be an integral part of a sash, frame, etc. so as to maintain the IG unit in the desired configuration.

When provided, the spacer 60 can be adhered to the two glass sheets 100, 110 by one or more beads of sealant, as is conventional and well-known to skilled artisans. In FIG. 38, the spacer 60 is shown with a primary sealant 55 on opposite sides of the spacer 60 and a secondary sealant 58 provided on an outside wall of the spacer 60. Another option is to omit the secondary sealant and provide a single deposit of sealant along both sides of the spacer and on the outside wall of the spacer. Various other known sealant arrangements/systems can alternatively be used. In other cases, the spacer may be omitted while one or more beads of sealant (optionally together with a moisture vapor barrier) are provided about the perimeter of the unit so as to encompass the cut aerogel sheet 300.

In some embodiments, the cut aerogel sheet 300 does not contact the spacer 60. For example, the cut aerogel sheet 300 may be separated (i.e., spaced apart) from the spacer 60 by about 1 mm to about 5 mm (e.g., about 2-4 mm, such as about 3 mm). When provided, the sealant 55, 58 between the spacer 60 and the two adjacent glass sheets 100, 110 can also be spaced from the cut aerogel sheet 300.

The first glass sheet 100 has opposed surfaces 120, 125, which preferably are opposed major surfaces (or “opposed faces”). Similarly, the second glass sheet 110 has opposed surfaces 130, 135, which preferably are opposed major surfaces. In some cases, surfaces 120 and 130 are interior surfaces facing a between-pane space 50, while surfaces 125 and 135 are exterior surfaces, e.g., such that surface 135 is an exterior surface exposed to an outdoor environment (and thus exposed to periodic contact with rain). This, however, is not required.

In some embodiments, glass sheet 110 is an outboard pane that defines both a #1 surface (i.e., surface 135) and a #2 surface (i.e., surface 130), while glass sheet 100 is an inboard pane that defines both a #3 surface (i.e., surface 120) and a #4 surface (i.e., surface 125). The insulating glazing unit 45 can optionally be mounted in a frame such that the #1 surface is exposed to an outdoor environment, while the #4 surface is exposed to an indoor environment (e.g., an environment inside a building). In such cases, the cut aerogel sheet 300 can optionally have a rectangular shape with four cut edge faces 42 that are all located outside a vision area of the insulating glazing unit 45.

The cut aerogel sheet 300 can be adhered to either the #2 surface or the #3 surface of the insulating glazing unit 45. Another option is to have cut aerogel sheets on both the #2 and the #3 surfaces. FIG. 38 illustrates one embodiment where the cut aerogel sheet 300 is adhered to an interior surface 120 (e.g., the #3 surface) of glass sheet 100. In another embodiment, the cut aerogel sheet 300 is on the optional low-emissivity coating 70, which is shown on the #2 surface (i.e., surface 130).

While FIG. 38 shows a double-pane insulating glazing unit, other embodiments provide a triple-pane insulating glazing unit having a cut aerogel sheet 300 on the #2 surface, the #3 surface, the #4 surface, or the #5 surface. In triple-pane embodiments, cut aerogel sheets can optionally be provided on both the #3 surface and either the #4 or #5 surface. Another option is to provide cut aerogel sheets on both the #2 surface and the #4 or #5 surface. In one preferred group of embodiments, however, the insulating glazing unit 45 includes only two glass panes 100, 110 and only one between-pane space 50.

The cut aerogel sheet 300 has a thickness AT. In some embodiments, the cut aerogel sheet 300 has a thickness AT in a range of from 1.5 mm to 15 mm, such as greater than 2 mm but less than 8 mm, or from 2 mm to 4 mm (e.g., 3 mm) or from 3 mm to 5 mm (e.g., 4 mm). It is to be appreciated, however, that other thicknesses can be used.

The between-pane space 50 has a thickness W, which is measured from the interior surface 130 of the second glass pane 110 to the interior surface 120 of the first glass pane 100. In certain embodiments, the cut aerogel sheet 300 does not occupy the entire thickness W of the between-pane space 50. In other cases, the cut aerogel sheet 300 occupies the entire thickness of the between-pane space.

A ratio of the thickness AT of the cut aerogel sheet 300 to the thickness W of the between-pane space 50 preferably is between 0.15 and 0.85. In some embodiments, the thickness W of the between-pane space 50 is at least 10 mm, optionally together with the thickness AT of the cut aerogel sheet 300 being greater than 2 mm but less than 8 mm. In certain preferred embodiments, the cut aerogel sheet 300 occupies less than 50% of the thickness W of the between-pane space 50 (e.g., less than 45%, less than 40%, or even less than 35% of the thickness W of the between-pane space 50).

In other embodiments, the cut aerogel sheet 300 occupies a majority of the thickness W of the between-pane space 50. In such instances, the thickness AT of the cut aerogel sheet 300 preferably is greater than 8 mm but less than 15 mm (e.g., about 10 mm), while the thickness of the gas gap G alongside the cut aerogel sheet 300 is optionally less than 5 mm (e.g., about 3 mm).

Certain embodiments provide an insulating glazing unit 45 that includes both a cut aerogel sheet 300 and a low-emissivity coating 70. In some cases, the cut aerogel sheet 300 is provided on an interior surface of one glass sheet and the low-emissivity coating 70 is provided on an interior surface of the other glass sheet. FIG. 38 illustrates an embodiment that includes a cut aerogel sheet 300 on a #3 surface (i.e., surface 120) and an optional low-emissivity coating 70 on a #2 surface (i.e., surface 130). In another embodiment, a cut aerogel sheet is provided on a #2 surface (i.e., surface 130) and an optional low-emissivity or solar control coating is provided on a #3 surface (i.e., surface 120). In still another embodiment, both a cut aerogel sheet and a coating (e.g., a low-emissivity or solar control coating) are provided on a #2 surface, such as by having a low-emissivity coating on the #2 surface and the aerogel sheet on the low-emissivity coating.

When provided, the optional low-emissivity coating 70 preferably includes at least one silver-inclusive film, which desirably contains more than 50% silver by weight (e.g., a metallic silver film). In certain preferred embodiments, the low-emissivity coating 70 includes three or more infrared-reflective films (e.g., silver-containing films). Low-emissivity coatings having three or more infrared-reflective films are described in U.S. patent application Ser. No. 11/546,152 and U.S. Pat. Nos. 7,572,511 and 7,572,510 and 7,572,509 and Ser. No. 11/545,211 and U.S. Pat. Nos. 7,342,716 and 7,339,728, the teachings of each of which are incorporated herein by reference. In some cases, the low-emissivity coating 70 includes four silver layers. In other cases, the low-emissivity coating can be a “single silver” or “double silver” low-emissivity coating, which are well-known to skilled artisans. Advantageous coatings of this nature are commercially available from, for example, Cardinal CG Company (Eden Prairie, Minnesota, U.S.A.).

Certain embodiments provide an insulating glazing unit 45 that includes both a cut aerogel sheet 300 and an optional transparent conductive oxide coating 85. In some cases, the cut aerogel sheet 300 is provided on an interior surface of a glass sheet and a transparent conductive oxide coating 85 is provided on an exterior surface of a glass sheet. In certain embodiments, a cut aerogel sheet 300 is provided on an interior surface and a transparent conductive oxide coating 85 is provided on an exterior surface of the same glass sheet. FIG. 38 illustrates an embodiment where the cut aerogel sheet 300 is provided on a #3 surface (i.e., surface 120) and an optional transparent conductive oxide coating 85 is provided on a #4 surface (i.e., surface 125). Another option is to provide the cut aerogel sheet on a #2 surface (i.e., surface 120) in combination with providing an optional transparent conductive oxide coating on a #1 surface, on a #4 surface, or both.

When provided, the optional transparent conductive oxide coating 85 can include indium tin oxide. In alternate embodiments, zinc aluminum oxide, SnO:Sb, SnO:F, or another known transparent conductive oxide is used. In some cases, transparent conductive oxide coating 85 comprises tin oxide together with antimony, fluorine, or another dopant. Further, in some cases, the transparent conductive oxide coating 85 is a sputtered film. In other embodiments, the transparent conductive oxide coating 85 comprises a pyrolytic film that includes tin (e.g., comprising tin oxide together with antimony, fluorine, or another dopant). Also, in some cases, the transparent conductive oxide coating 85 includes carbon nanotubes.

When provided, the transparent conductive oxide coating 85 preferably is provided at a thickness of 10,000 Å or less, such as between about 1,000 Å and about 7,000 Å, e.g., from 1,000 Å to 1,750 Å, such as about 1,300-1,600 Å. For any embodiment where the transparent conductive oxide coating 85 is provided, it can optionally comprise a transparent conductive oxide film having a thickness of from 1,000 Å to 1,750 Å.

The transparent conductive oxide coating 85 can, for example, be a coating of the type described in any of U.S. Pat. No. 9,862,640 or 10,000,965 or 10,000,411 or 11,155,493, the teachings of which concerning the transparent conductive oxide coating are hereby incorporated herein by reference. In the embodiment of FIG. 38, the illustrated transparent conductive oxide coating 85 can optionally be omitted.

In some cases, the insulating glazing unit 45 includes both a transparent conductive oxide coating 85 and a low-emissivity coating 70. This, however, is by no means required. For example, in some cases, the insulating glazing unit 45 includes the low-emissivity coating 70 but is devoid of the transparent conductive oxide coating 85. This can optionally be the case for the embodiment shown in FIG. 38.

Other embodiments provide a method of making an insulating glazing unit. The method comprises forming a cut aerogel sheet 300 according to any method described herein, and assembling the cut aerogel sheet together with two or more glass sheets 100, 110 in forming the insulating glazing unit. The cut aerogel sheet 300 can be adhered to a surface of a glass sheet (e.g., through van der Waals forces, or by using an optical adhesive). The cut aerogel sheet 300 may be placed either manually or, more preferably, with robotics. In some embodiments, the cut aerogel sheet 300 is adhered to a temporary surface for handling and placement. The cut aerogel sheet 300 can be picked up using electrostatic adhesion, e.g., using commercially available Stackit robots manufactured by Grabit, Inc. (Sunnyvale, California, U.S.A.) or using technology described in U.S. patent application Ser. No. 18/536,611, the contents of which are incorporated herein by reference.

Certain embodiments provide a laminated glass assembly. FIG. 39 illustrates a laminated glass assembly 80 comprising a first glass sheet 100, a second glass sheet 110 and a cut aerogel sheet 300. In some embodiments, the laminated glass assembly 80 also includes a spacer (not shown). In other cases, the spacer is omitted and the laminated glass assembly 80 just has one or more beads of sealant 58 (optionally together with a foil moisture barrier, tape, or both) at the perimeter of the assembly.

The cut aerogel sheet 300 can be formed according to any process described herein and can have any of the features and properties discussed herein. Likewise, the cut aerogel sheet 300 of the laminated glass assembly 80 can have the same dimensions and material properties as the cut aerogel sheet 300 described herein for the insulating glazing unit 45.

The laminated glass assembly 80 can also include a polymer interlayer 400. The polymer interlayer 400 preferably is a tear-resistant polymer layer. In some cases, it is a sheet of ionoplast plastic. In other cases, it is a sheet of polyvinyl butyral (PVB). Various other materials known to be suitable for the interlayer of a laminated glass panel can also be used. In certain embodiments, both glass sheets 100, 110 can be clear 3 mm soda-lime float glass and the polymer interlayer 400 can be 0.30-inch thick PVB. It is to be appreciated, however, that these details are by no means limiting.

FIG. 39 shows an embodiment having a single polymer interlayer 400. In such embodiments, the cut aerogel sheet 300 can be adhered to one of the two glass sheets 100, 110 (e.g., through van der Waals forces, or by using an optical adhesive). In other embodiments, there are two polymer interlayers. In such embodiments, the cut aerogel sheet is sandwiched between, and laminated to, the two polymer interlayers. In such cases, the polymer interlayers are each in contact with one of the glass sheets on opposite sides of the cut aerogel sheet. In still other embodiments, the polymer interlayer(s) are omitted. In embodiments of this nature, the cut aerogel sheet is sandwiched between the two glass sheets 100, 110, optionally with adhesive between the aerogel sheet 300 and one or both glass sheets.

Other embodiments provide a method of making a laminated glass assembly. Here too, the method comprises forming a cut aerogel sheet 300 according to any method described herein and assembling the cut aerogel sheet 300 together with glass sheets 100, 110 in forming the laminated glass assembly. The cut aerogel sheet 300, the glass sheets, and one or more optional polymer interlayers can be assembled together as part of a laminated glass assembly using any suitable techniques. The lamination process may include various known autoclave glass lamination techniques. In some other cases, the process may include one or more steps described in U.S. Pat. Nos. 7,117,914 and 7,143,800, the teachings of which concerning non-autoclave glass lamination are incorporated herein by reference.

While some preferred embodiments of the invention have been described, it should be understood that various changes, adaptations and modifications may be made therein without departing from the spirit of the invention and the scope of the appended claims.

### EMBODIMENTS

1. A method comprising:
providing a wet gel sheet on a cutting support surface, so that a bottom face of the wet gel sheet is supported by the cutting support surface and a top face of the wet gel sheet faces in an opposite direction, the wet gel sheet being a porous material comprising solvent within at least some pores; and cutting the wet gel sheet by moving a blade along a cutting path;
wherein the wet gel sheet is stationary during the cutting.
   2. The method of claim 1 wherein the cutting comprises moving the blade along the cutting path such that the cutting edge of the blade moves from the top face of the wet gel sheet to the bottom face of the wet gel sheet.
   3. The method of claim 1 or 2 wherein the blade has a thickness of 1000 microns or less, for example 900 microns or less, 800 microns or less, 700 microns or less, 600 microns or less, 500 microns or less, 400 microns or less, 300 microns or less, 200 microns or less, or 100 microns or less.
   4. The method of any preceding claim wherein the blade has an edge angle of from 15 degrees to 45 degrees, for example from 20 degrees to 30 degrees.
   5. The method of any preceding claim further comprising coating at least a portion of the wet gel sheet with a solution comprising the solvent and performing the cutting before said solution fully evaporates.
   6. The method of claim 5 further comprising performing the cutting while continuously misting at least the portion of the wet gel sheet with the solution comprising the solvent.
   7. The method of claim 6 wherein the portion of the wet gel sheet comprises areas of the top face.
   8. The method of claim 7 wherein the portion of the wet gel sheet comprises an entirety of the entire top face.
   9. The method of any one of claims 1-5 wherein the wet gel sheet is submerged in a solution comprising the solvent during the cutting.
   10. The method of claim 9 wherein the wet gel sheet is fully submerged in the solution comprising the solvent during the cutting.
   11. The method of any one of claims 5-10 wherein the solution comprising the solvent consists essentially of the solvent.
   12. The method of any preceding claim wherein the solvent is a flammable solvent and the cutting does not produce a spark or flame.
   13. The method of claim 12 wherein the flammable solvent is selected from the group consisting of methanol, ethanol, isopropanol, N,N-dimethylformadide (DMF) and acetone.
   14. The method of any preceding claim wherein the wet gel sheet lies along a first plane and the cutting path extends along a second plane perpendicular to the first plane.
   15. The method of claim 14 wherein the first plane is a horizontal plane and the second plane is a vertical plane.
   16. The method of claim 15 wherein the cutting produces a cut vertical edge face on the wet gel sheet, the cut vertical edge face being perpendicular to the bottom face of the wet gel sheet.
   17. The method of claim 16 wherein the cut vertical edge face is devoid of cracks visible to the naked eye.
   18. The method of any preceding claim wherein the cutting does not remove any chemical component from the wet gel sheet or otherwise change a chemical composition of the wet gel sheet.
   19. The method of any preceding claim wherein the blade is elongated so as to extend entirely across a width or a length of the wet gel sheet during the cutting.
   20. The method of claim 19 wherein the blade is elongated so as to extend beyond the width or the length of the wet gel sheet during the cutting.
   21. The method of any preceding claim wherein the blade moves along the cutting path without vibrating.
   22 The method of any preceding claim wherein the blade is a circular, rotating blade.
   23. The method of claim 22 wherein the cutting further comprises moving the circular, rotating blade along a second cutting path such that the cutting edge moves from a first edge face of the wet gel sheet to a second edge face.
   24 The method of any preceding claim wherein the blade is devoid of serrations.
   25. The method of any preceding claim wherein the cutting only involves the blade moving along the cutting path and is devoid of using any second blade.
   26. The method of any preceding claim wherein the cutting only involves moving the blade along the cutting path and is devoid of using any laser.
   27. The method of any preceding claim wherein the blade moves along the cutting path at a controlled speed.
   28. The method of claim 27 wherein the controlled speed is from 5 mm/second to 500 mm/second, such as from 5 mm/second to 15 mm/second.
   29. The method of claim 27 or 28 wherein the controlled speed remains constant during the cutting.
   30. The method of any preceding claim wherein the cutting support surface is a continuous, flat surface that is in contact with and supports an entirety of the bottom face of the wet gel sheet.
   31. The method of claim 30 wherein the continuous, flat surface is a rigid surface.
   32. The method of any preceding claim wherein the cutting support surface includes a backing surface area located directly under the blade as well as a front adjacent surface area and a rear adjacent surface area, the front adjacent surface area being located to a front side of the blade and the rear adjacent surface area being located to a rear side of the blade, and wherein the backing surface area, the front adjacent surface area and the rear adjacent surface area are all continuous to one another.
   33. The method of claim 32 wherein the backing surface area, the front adjacent surface area and the rear adjacent surface area are all flat, horizontal and parallel to one another.
   34. The method of any preceding claim wherein the wet gel sheet has a thickness of from 1 mm to 7 mm, preferably from 3 mm to 5 mm.
   35. The method of any preceding claim wherein the wet gel sheet is a silica wet gel sheet.
   36. The method of claim 35 wherein the silica wet gel sheet consists essentially of silica.
   37. The method of any preceding claim wherein the wet gel sheet is devoid of fibers.
   38. The method of any preceding claim wherein the wet gel sheet is not wound before or after the cutting.
   39. The method of any preceding claim wherein the wet gel sheet is an alcogel sheet and the solvent is an alcohol.
   40. The method of claim 39 wherein the alcogel sheet is a silica alcogel sheet and the alcohol is methanol.
   41. The method of any preceding claim wherein the method further includes, prior to the cutting, performing a solvent exchange on the wet gel sheet, such that prior to the solvent exchange the wet gel sheet contains water as the solvent whereas after the solvent exchange the wet gel sheet contains an alcohol as the solvent.
   42. The method of any preceding claim wherein the method further includes, after the cutting, aging the wet gel sheet.
   43. The method of any preceding claim wherein the method further includes, after the cutting, drying the wet gel sheet to convert it to an aerogel sheet.
   44. The method of claim 43 wherein the drying the wet gel sheet involves a drying operation selected from the group consisting of supercritical drying, freeze drying and ambient drying.
   45. The method of claim 44 wherein the drying operation is supercritical drying.
   46. The method of claim 43 wherein the aerogel sheet is a transparent, brittle aerogel sheet.
   47. The method of any preceding claim further comprising moving the cutting support surface away from the blade while the blade remains stationary, thereby removing a portion of the wet gel sheet.
   48. The method of claim 47 wherein the blade remains stationary while the cutting edge of the blade is adjacent the bottom face of the wet gel sheet.
   49. The method of claim 48 wherein the blade has a blade height that extends from the cutting edge to a spine and the blade height is greater than a total thickness of the wet gel sheet.
   50. The method of any one of claims 47-49 further comprising providing the cutting support surface on an underlying base such that the cutting support surface is movable over the underlying base and the step of moving the cutting support surface away from the blade comprises moving the cutting support surface over the underlying base.
   51. An aerogel sheet formed by a process comprising:
providing a wet gel sheet on a cutting support surface, so that a bottom face of the wet gel sheet is supported by the cutting support surface and a top face of the wet gel sheet faces in an opposite direction, the wet gel sheet being a porous material comprising solvent within at least some pores;
cutting the wet gel sheet to have a specified dimension by moving a blade along a cutting path; and
drying the wet gel sheet to form the aerogel sheet.
   52. The aerogel sheet of claim 51 wherein the cutting comprises moving the blade along the cutting path such that the cutting edge of the blade moves from the top face of the wet gel sheet to the bottom face of the wet gel sheet.
   53. The aerogel sheet of claim 51 or 52 wherein the blade has a thickness of 1000 microns or less, for example 900 microns or less, 800 microns or less, 700 microns or less, 600 microns or less, 500 microns or less, 400 microns or less, 300 microns or less, 200 microns or less, or 100 microns or less.
   54. The aerogel sheet of any preceding claim wherein the blade has an edge angle of from 15 degrees to 45 degrees, for example from 20 degrees to 30 degrees.
   55. The aerogel sheet of any preceding claim wherein the aerogel sheet has a cut edge face, created by the cutting, that is devoid of cracks visible to the naked eye.
   56. The aerogel sheet of claim 55 wherein the cut edge face is a vertical cut edge face, such that the cutting path is perpendicular to the cutting support surface.
   57. The aerogel sheet of any preceding claim wherein the aerogel sheet has a thickness of from 1 mm to 7 mm, preferably from 3 mm to 5 mm.
   58. The aerogel sheet of any preceding claim wherein the aerogel sheet is a transparent, brittle aerogel sheet having a major dimension of at least 0.6 meter.
   59. The aerogel sheet of any preceding claim wherein the aerogel sheet is sufficiently rigid that it cannot be wound.
   60. The aerogel sheet of any preceding claim wherein the aerogel sheet has a visible transmission of 95% or more.
   61. The aerogel sheet of any preceding claim wherein the aerogel sheet has a haze value of less than 5%.
   62. The aerogel sheet of any preceding claim wherein the aerogel sheet has a density of from 100 mg/cc to 200 mg/cc.
   63. The aerogel sheet of any preceding claim wherein the aerogel sheet is a silica aerogel sheet.
   64. The aerogel sheet of claim 63 wherein the silica aerogel sheet consists essentially of silica.
   65. The aerogel sheet of any preceding claim wherein the aerogel sheet is devoid of fibers.
   66. The aerogel sheet of any preceding claim wherein the wet gel sheet is stationary during the cutting.
   67. The aerogel sheet of any preceding claim wherein during the cutting, the wet gel sheet lies along a first plane and the cutting path extends along a second plane perpendicular to the first plane.
   68. The aerogel sheet of claim 67 wherein the first plane is a horizontal plane and the second plane is a vertical plane.
   69. The aerogel sheet of any preceding claim wherein a portion of the wet gel sheet is coated with a solution comprising the solvent during the cutting.
   70. The aerogel sheet of any preceding claim wherein a portion of the wet gel sheet is continuously misted with the solution comprising the solvent during the cutting.
   71. The aerogel sheet of claim 69 or 70 wherein the portion of the wet gel sheet comprises areas of the top face.
   72. The aerogel sheet of claim 71 wherein the portion of the wet gel sheet comprises an entirety of the top face.
   73. The aerogel sheet of any one of claims 51-68 wherein the wet gel sheet is submerged in the solution comprising the solvent during the cutting.
   74. The aerogel sheet of claim 73 wherein the wet gel sheet is fully submerged in the solution comprising the solvent during the cutting.
   75. The aerogel sheet of any one of claims 69-74 wherein the solution comprising the solvent is a solution consisting essentially of the solvent.
   76 The aerogel sheet of any preceding claim wherein the wet gel sheet is an alcogel sheet and the solvent comprises alcohol.
   77. The aerogel sheet of claim 76 wherein the alcogel sheet is a silica alcogel sheet and the alcohol is methanol.
   78. The aerogel sheet of any preceding claim wherein the solvent is a flammable solvent and the cutting does not produce a spark or flame.
   79. The aerogel sheet of claim 78 wherein the flammable solvent is selected from the group consisting of methanol, ethanol, isopropanol, N,N-dimethylformadide (DMF) and acetone.
   80. The aerogel sheet of any preceding claim wherein the cutting only involves the blade moving along the cutting path, is devoid of using any second blade, and is devoid of using any laser.
   81. The aerogel sheet of any preceding claim wherein the blade is elongated so as to extend entirely across a width or a length of the wet gel sheet during the cutting.
   82. The aerogel sheet of claim 81 wherein the blade is elongated so as to extend beyond the width or the length of the wet gel sheet during the cutting.
   83. The aerogel sheet of any preceding claim wherein the blade moves along the cutting path without vibrating 84. The aerogel sheet of any preceding claim wherein the blade is devoid of serrations.
   85. The aerogel sheet of any preceding claim wherein the blade moves along the cutting path at a controlled speed.
   86. The aerogel sheet of claim 85 wherein the controlled speed is from 5 mm/second to 500 mm/second, such as from 5 mm/second to 15 mm/second.
   87. The aerogel sheet of claim 85 or 86 wherein the controlled speed remains constant during the cutting.
   88. The aerogel sheet of any preceding claim wherein the cutting support surface is a continuous, flat surface that is in contact with and supports an entirety of the bottom face of the wet gel sheet.
   89. The aerogel sheet of claim 88 wherein the continuous, flat surface is a rigid surface.
   90. The aerogel sheet of any preceding claim wherein the cutting support surface includes a backing surface area located directly under the blade as well as a front adjacent surface area and a rear adjacent surface area, the front adjacent surface area being located to a front side of the blade and the rear adjacent surface area being located to a rear side of the blade, and wherein the backing surface area, the front adjacent surface area and the rear adjacent surface area are all continuous to one another.
   91. The aerogel sheet of claim 90 wherein the backing surface area, the front adjacent surface area and the rear adjacent surface area are all flat, horizontal and parallel to one another.
   92. The aerogel sheet of any preceding claim wherein the process further includes, prior to the cutting, performing a solvent exchange on the wet gel sheet, such that prior to the solvent exchange the wet gel sheet contains water as the solvent whereas after the solvent exchange the wet gel sheet contains an alcohol as the solvent.
   93. The aerogel sheet of any preceding claim wherein the process further includes, after the cutting and before the drying, aging the wet gel sheet.
   94. The aerogel sheet of any preceding claim wherein the cutting does not remove any chemical component from the wet gel sheet or otherwise change a chemical composition of the wet gel sheet.
   95. The aerogel sheet of any preceding claim wherein the process further includes moving the cutting support surface away from the blade while the blade remains stationary, thereby removing a portion of the wet gel sheet.
   96. The aerogel sheet of 95 wherein the blade remains stationary while the cutting edge of the blade is adjacent the bottom face of the wet gel sheet.
   97. The aerogel sheet of 96 wherein the blade has a blade height that extends from the cutting edge to a spine and the blade height is greater than a total thickness of the wet gel sheet.
   98. The aerogel sheet of any one of claims 95-97 wherein the process further includes providing the cutting support surface on an underlying base such that the cutting support surface is movable over the underlying base and the step of moving the cutting support surface away from the blade comprises moving the cutting support surface over the underlying base.
   99. An article comprising a glass sheet and an aerogel sheet, the aerogel sheet having a specified dimension and being located alongside a major surface of the glass sheet, wherein the article is formed by a process comprising:
providing a wet gel sheet on a cutting support surface, so that a bottom face of the wet gel sheet is supported by the cutting support surface and a top face of the wet gel sheet faces in an opposite direction, the wet gel sheet being a porous material comprising solvent within at least some pores;
cutting the wet gel sheet to have the specified dimension by moving a blade along a cutting path;
drying the wet gel sheet to form the aerogel sheet; and
mounting the aerogel sheet alongside the major surface of the glass sheet.
   100. The article of claim 99 wherein the cutting comprises moving the blade along the cutting path such that the cutting edge of the blade moves from the top face of the wet gel sheet to the bottom face of the wet gel sheet.
   101. The article of claim 99 or 100 wherein the blade has a thickness of 1000 microns or less, for example 900 microns or less, 800 microns or less, 700 microns or less, 600 microns or less, 500 microns or less, 400 microns or less, 300 microns or less, 200 microns or less, or 100 microns or less.
   102. The article of any preceding claim wherein the blade has an edge angle of from 15 degrees to 45 degrees, for example from 20 degrees to 30 degrees.
   103. The article of any preceding claim wherein the aerogel sheet has a cut edge face, created by the cutting, that is devoid of cracks visible to the naked eye.
   104. The article of claim 103 wherein the cut edge face is a vertical cut edge face, the vertical cut edge face being perpendicular to the major surface of the glass sheet.
   105. The article of any preceding claim wherein the aerogel sheet has a thickness of from 1 mm to 7 mm, preferably from 3 mm to 5 mm.
   106. The article of any preceding claim wherein the aerogel sheet is a transparent, brittle aerogel sheet having a major dimension of at least 0.6 meter.
   107. The article of any preceding claim wherein the aerogel sheet is sufficiently rigid that it cannot be wound.
   108. The article of any preceding claim wherein the aerogel sheet has a visible transmission of 95% or more.
   109. The article of any preceding claim wherein the aerogel sheet has a haze value of less than 5%.
   110. The article of any preceding claim wherein the aerogel sheet has a density of from 100 mg/cc to 200 mg/cc.
   111. The article of any preceding claim wherein the aerogel sheet is a silica aerogel sheet.
   112. The article of claim 111 wherein the silica aerogel sheet consists essentially of silica.
   113. The article of any preceding claim wherein the aerogel sheet is devoid of fibers.
   114. The article of any preceding claim wherein the wet gel sheet is stationary during the cutting.
   115. The article of any preceding claim wherein during the cutting, the wet gel sheet lies along a first plane and the cutting path extends along a second plane perpendicular to the first plane.
   116. The article of claim 115 wherein the first plane is a horizontal plane and the second plane is a vertical plane.
   117. The article of any preceding claim wherein a portion of the wet gel sheet is coated with a solution comprising the solvent during the cutting.
   118. The article of claim 117 wherein the portion of the wet gel sheet is continuously misted with the solution comprising the solvent during the cutting.
   119. The article of claim 117 or 118 wherein the portion of the wet gel sheet comprises areas of the top face.
   120. The article of claim 119 wherein the portion of the wet gel sheet comprises an entirety of the top face.
   121. The article of any one of claims 99-116 wherein the wet gel sheet is submerged in the solution comprising the solvent during the cutting.
   122. The article of claim 121 wherein the wet gel sheet is fully submerged in the solution comprising the solvent during the cutting.
   123. The article of any one of claims 117-122 wherein the solution comprising the solvent is a solution consisting essentially of the solvent.
   124. The article of any preceding claim wherein the wet gel sheet is an alcogel sheet and the solvent comprises alcohol.
   125. The article of claim 124 wherein the alcogel sheet is a silica alcogel sheet and the alcohol is methanol.
   126. The article of any preceding claim wherein the solvent is a flammable solvent and the cutting does not produce a spark or flame.
   127. The article of claim 126 wherein the flammable solvent is selected from the group consisting of methanol, ethanol, isopropanol, N,N-dimethylformadide (DMF) and acetone.
   128. The article of any preceding claim wherein the cutting only involves the blade moving along the cutting path, is devoid of using any second blade, and is devoid of using any laser.
   129. The article of any preceding claim wherein the blade is elongated so as to extend entirely across a width or a length of the wet gel sheet during the cutting.
   130. The article of claim 129 wherein the blade is elongated so as to extend beyond the width or the length of the wet gel sheet during the cutting.
   131. The article of any preceding claim wherein the blade moves along the cutting path without vibrating.
   132. The article of any preceding claim wherein the blade is devoid of serrations.
   133. The article of any preceding claim wherein the blade moves along the cutting path at a controlled speed.
   134. The article of claim 133 wherein the controlled speed is from 5 mm/second to 500 mm/second, such as from 5 mm/second to 15 mm/second.
   135. The article of claim 133 or 134 wherein the controlled speed remains constant during the cutting.
   136. The article of any preceding claim wherein the cutting support surface is a continuous, flat surface that is in contact with and supports an entirety of the bottom face of the wet gel sheet.
   137. The article of claim 136 wherein the continuous, flat surface is a rigid surface.
   138. The article of any preceding claim wherein the cutting support surface includes a backing surface area located directly under the blade as well as a front adjacent surface area and a rear adjacent surface area, the front adjacent surface area being located to a front side of the blade and the rear adjacent surface area being located to a rear side of the blade, and wherein the backing surface area, the front adjacent surface area and the rear adjacent surface area are all continuous to one another.
   139. The article of claim 138 wherein the backing surface area, the front adjacent surface area and the rear adjacent surface area are all flat, horizontal and parallel to one another.
   140. The article of any preceding claim wherein the process further includes, prior to the cutting, performing a solvent exchange on the wet gel sheet, such that prior to the solvent exchange the wet gel sheet contains water as the solvent whereas after the solvent exchange the wet gel sheet contains an alcohol as the solvent.
   141. The article of any preceding claim wherein the process further includes, after the cutting and before the drying, aging the wet gel sheet.
   142. The article of any preceding claim wherein the cutting does not remove any chemical component from the wet gel sheet or otherwise change a chemical composition of the wet gel sheet.
   143. The article of any preceding claim wherein the process further includes moving the cutting support surface away from the blade while the blade remains stationary, thereby removing a portion of the wet gel sheet.
   144. The article of 143 wherein the blade remains stationary while the cutting edge of the blade is adjacent the bottom face of the wet gel sheet.
   145. The article of 144 wherein the blade has a blade height that extends from the cutting edge to a spine and the blade height is greater than a total thickness of the wet gel sheet.
   146. The article of any one of claims 143-145 wherein the process further includes providing the cutting support surface on an underlying base such that the cutting support surface is movable over the underlying base and the step of moving the cutting support surface away from the blade comprises moving the cutting support surface over the underlying base.

What is claimed is:

1. An article comprising a glass sheet and an aerogel sheet, the aerogel sheet having a specified dimension and being located alongside a major surface of the glass sheet, wherein the article is formed by a process comprising:
providing a wet gel sheet on a cutting support surface, so that a bottom face of the wet gel sheet is supported by the cutting support surface and a top face of the wet gel sheet faces in an opposite direction, the wet gel sheet being a porous material comprising solvent within at least some pores;
cutting the wet gel sheet to have the specified dimension by moving a blade along a cutting path;
drying the wet gel sheet to form the aerogel sheet; and
mounting the aerogel sheet alongside the major surface of the glass sheet.

2. The article of claim 1 wherein the cutting comprises moving the blade along the cutting path such that the cutting edge of the blade moves from the top face of the wet gel sheet to the bottom face of the wet gel sheet.

3. The article of claim 1 wherein the aerogel sheet has a cut edge face, created by the cutting, that is devoid of cracks visible to the naked eye.

4. The article of claim 3 wherein the cut edge face is a vertical cut edge face, the vertical cut edge face being perpendicular to the major surface of the glass sheet.

5. The article of claim 1 wherein the aerogel sheet has a thickness of from 1 mm to 7 mm.

6. The article of claim 1 wherein the aerogel sheet is a transparent, brittle aerogel sheet having a major dimension of at least 0.6 meter.

7. The article of claim 1 wherein the aerogel sheet is sufficiently rigid that it cannot be wound.

8. The article of claim 1 wherein the aerogel sheet has a visible transmission of 95% or more.

9. The article of claim 1 wherein the aerogel sheet has a haze value of less than 5%.

10. The article of claim 1 wherein the aerogel sheet has a density of from 100 mg/cc to 200 mg/cc.

11. The article of claim 1 wherein the aerogel sheet is a silica aerogel sheet.

12. The article of claim 11 wherein the silica aerogel sheet consists essentially of silica.

13. The article of claim 1 wherein the aerogel sheet is devoid of fibers.

14. The article of claim 1 wherein the wet gel sheet is an alcogel sheet and the solvent comprises alcohol.

15. The article of claim 14 wherein the alcogel sheet is a silica alcogel sheet and the alcohol is methanol.

16. The article of claim 1 wherein the process further includes, prior to the cutting, performing a solvent exchange on the wet gel sheet, such that prior to the solvent exchange the wet gel sheet contains water as the solvent whereas after the solvent exchange the wet gel sheet contains an alcohol as the solvent.

17. The article of claim 1 wherein the cutting does not remove any chemical component from the wet gel sheet or otherwise change a chemical composition of the wet gel sheet.

18. The article of claim 1 wherein a portion of the wet gel sheet is coated with a solution comprising the solvent during the cutting.

19. The article of claim 18 wherein the portion of the wet gel sheet is continuously misted with the solution comprising the solvent during the cutting.

20. The article of claim 18 wherein the solution comprising the solvent is a solution consisting essentially of the solvent.
